(19) United States
(12) Patent Application Publication
(10) Pub. No.: US 2025/0390952 A1
(43) Pub. Date: Dec. 25, 2025

(54) METHOD, APPARATUS AND SYSTEM FOR EQUALIZING LATENCIES IN PUBLICATION OF EVENT DATA TO MULTIPLE CLIENT DEVICES

(71) Applicant: BGC PARTNERS, L.P., NEW YORK, NY (US)

(72) Inventors: Bijoy Paul, New York, NY (US); Jonathan Joshua, New York, NY (US)

(73) Assignee: BGC PARTNERS, L.P., NEW YORK, NY (US)

(21) Appl. No.: 19/310,477

(22) Filed: Aug. 26, 2025

Related U.S. Application Data
(63) Continuation of application No. PCT/US23/14105, filed on Feb. 28, 2023.

(51) Int. Cl. G06Q 40/04; G06F 9/54

(52) U.S. Cl. CPC G06Q 40/045; G06F 9/542

(57) ABSTRACT

Method, apparatus and system may control distribution of event data of an event to one or more subscribers, based on filter information indicating one or more subscribers permissioned to receive at least one some portion of the event data as filtered event data, an event time of the event, and network latencies associated with transmitting the filtered event data to client devices of respective subscribers permissioned to receive the filtered event data. Distribution messages containing the filtered event data are transmitted to the client devices at distribution times that equalize network latencies associated with transmitting the distribution messages to the client devices, to provide that the client devices receive respective distribution messages including filtered event data of the same event at a same or substantially the same time.

### CROSS REFERENCE TO RELATED APPLICATIONS

This application is a continuation of PCT Application No. PCT/US23/14105 filed Feb. 28, 2023, which is incorporated herein by reference in its entirety.

### TECHNICAL FIELD

The present disclosure generally relates to publishing an event to computing devices based on filter information and, in particular, equalizing latencies associated with transmitting, from a computing platform, messages containing filtered event data of an event to respective client devices.

### BACKGROUND

Computing devices of respective entities exchange data with other computing devices of other respective entities over communication networks for multitudes of applications. The speed of data transfer from one computing device to another computing device depends, in part, on network latency associated with transmission of a message containing the data from the one computing device, over a communication path, to the another computing device. For example, a computing platform that distributes event data of an event, for example, a news event, a sporting event, or a financial event, to multiple client devices typically transmits messages containing the event data to the client devices respectively over communication paths having different path lengths and network properties, such as a communication medium or communication protocol. As the network properties and the respective lengths of the communication paths between the computing platform and each of the client devices typically are different, different propagation delays typically are associated with transmission of event data to client devices over respective communication paths. The different propagation delays may cause event data of an event to be received at different times at respective client devices.

In various event data distribution implementations, it is desired that event data of a same event, which is distributed from a computing platform to multiple client devices, be received at a same or substantially the same time at each of the client devices. Differences in network latencies associated with data transmission from the computing platform, over respective communication paths, to the multiple client devices, however, present technical difficulties to distribute messages containing event data, so that each of the client devices may receive a message containing event data of a same event at a same or substantially the same time.

In one example, in an electronic asset trading system, a matching engine or trading exchange may generate an event based on, for example, submission of a new order for a financial asset or execution of a trade for a financial asset based on an order, and provide event data of the event to a computing platform configured to publish event data of the event to computing devices of users which are permissioned to receive details of the event. Each of the users, who may be a subscriber to an event publication service of the computing platform, desires to receive a message containing event data of the event at a same time that others of the users receive event data of the event, which avoids the potential for unfair exploitation of asset trading information by one user who receives event data of the event before another user. Differences in network latencies associated with transmission of messages containing event data to the computing devices of respective users, however, present technical difficulties at the computer platform to distribute event data from a trading exchange or matching engine in a manner that ensures simultaneous or substantially simultaneous receipt of event data of a same event at computing devices of respective users permissioned to receive event data of the same event.

Accordingly, there exists a need for method, apparatus and system for electronic communication in communication networks that may equalize network latencies associated with transmission of event data of a same event from a computing platform to respective multiple computing devices, to provide that event data of the same event is received at the same or substantially the same time by computing devices of respective users permissioned to receive event data of the same event.

### SUMMARY

In accordance with an aspect of the present disclosure, a system may include at least one programmable integrated circuit communicatively coupled to a plurality of computing devices, in which each computing device includes an event circuit; in which the at least one programmable integrated circuit is configured to: receive, from each event circuit, an event message indicating an event and an event time of the event, in which the event time is based on a time of an electronic clock of the system when the event message indicating the event is transmitted from the event circuit, and in which the event message has a first message format; for each event indicated in an event message from an event circuit, determine event data and an event time of the event; generate, based on filter information, a distribution message including filtered event data of the event for a given client device of a plurality of client devices and the event time; determine whether a distribution time of the distribution message is satisfied, by comparing a current time of the electronic clock and a sum of the event time, a hold delay and a network latency offset associated with transmission of the distribution message to the given client device, in which the network latency offset includes a propagation delay offset corresponding to a communication path extending from the at least one programmable integrated circuit to the given client device, in which each client device of the plurality of client devices has a propagation delay offset corresponding to a communication path extending from the at least one programmable integrated circuit to the each client device; and when the distribution time of the distribution message is determined to be satisfied, cause a message delivery circuit of the at least one programmable integrated circuit to transmit the distribution message to the given client device, in which the distribution message is transmitted having a second message format different from the first message format.

In accordance with an aspect of the present disclosure, a method may be for distributing event information by at least one programmable integrated circuit communicatively coupled to a plurality of computing devices, in which each computing device includes an event circuit, in which the method may include: receiving at the at least one programmable integrated circuit, from each event circuit, an event message indicating an event and an event time of the event, in which the event time is based on a time of an electronic clock of the at least one programmable integrated circuit when the event message indicating the event is transmitted from the event circuit, and in which the event message has a first message format; for each event indicated in an event message from an event circuit, determining, by the at least one programmable integrated circuit, event data and an event time of the event; generating, by the at least one programmable integrated circuit, based on filter information, a distribution message including filtered event data of the event for a given client device of a plurality of client devices and the event time; determining, by the at least one programmable integrated circuit, whether a distribution time of the distribution message is satisfied, by comparing a current time of the electronic clock and a sum of the event time, a hold delay and a network latency offset associated with transmission of the distribution message to the given client device, in which the network latency offset includes a propagation delay offset corresponding to a communication path extending from the at least one programmable integrated circuit to the given client device, in which each client device of the plurality of client devices has a propagation delay offset corresponding to a communication path extending from the at least one programmable integrated circuit to the each client device; and when the distribution time of the distribution message is determined to be satisfied, causing, by the at least one programmable integrated circuit, a message delivery circuit of the at least one programmable integrated circuit to transmit the distribution message to the given client device, in which the distribution message is transmitted having a second message format different from the first message format.

### BRIEF DESCRIPTION OF THE DRAWINGS

FIG. 1 is a block diagram of an exemplary computing apparatus, according to the present disclosure.

FIG. 2 is a block diagram of an exemplary system, according to the present disclosure.

FIG. 3 is a block diagram of an exemplary system, according to the present disclosure.

FIGS. 4A, 4B and 4C illustrate an exemplary high level flow diagram of an exemplary method of distributing event data of a same event to multiple client devices with network latency equalization, according to the present disclosure.

FIG. 5 is a block diagram of a portion of an exemplary system, according to the present disclosure.

### DETAILED DESCRIPTION

The technology of the present disclosure relates to, by way of example, a computer and networking architecture that may control distributing event data of a same event from a computing platform to a plurality of client devices of respective users permissioned to receive at least a portion of the event data of the same event, and equalizing network latencies associated with transmission from the computing platform of distribution messages containing filtered event data as the at least a portion of the event data of the same event respectively to the client devices, to ensure simultaneous or substantially simultaneous receipt of filtered event data of the same event at the client devices.

In one embodiment, a computing system may distribute filtered event data of an event, for example, a news event, a sporting event, or a financial event, to multiple client devices of respective permissioned users, with network latency equalization, where the computing system includes an architecture containing at least one programmable hardware device, for example, a reprogrammable logic device such as a field programmable gate array (FPGA), and at least one processor. The computing system may receive event data of respective events from event sources, where each event has an event time corresponding to a time of a system clock of the computing system when event data of the event is transmitted to the computing system; generate, based on filter information, distribution messages containing filtered event data of a specific event for respective permissioned users; and determine distribution times for transmission respectively of the distribution messages containing the filtered event data of the specific event, where the distribution times provide that the distribution messages may be received at the same or substantially the same time at the client devices respectively of the permissioned users. In one embodiment, distribution times for respective distribution messages for a specific event may be a function of the event time of the specific event, hold delays for the respective distribution messages, and network latency offsets associated with transmission of the distribution messages respectively to client devices. The network latency offsets may include propagation delay offsets that equalize differences in propagation delays associated with respective communication paths extending from the at least one programmable hardware device of the computing system from which the distribution messages are transmitted to the client devices. In addition, the network latency offsets may include serialization offsets that equalize differences in serialization delays associated with transmission, from the at least one programmable hardware device onto communication paths, of the respective distribution messages for a specific event including filtered event data having different byte sizes.

In one exemplary embodiment, a computing system may control distributing event data of an event, such as asset trading details of an order to trade of an asset, such as an equity, a bond, or cryptocurrency, cancelation of an existing order to trade an asset, and submission of a new order to trade an asset, for simultaneous or substantially simultaneous receipt at client devices of respective users permissioned to receive at least some portion of the event data as filtered event data. The computing system may include at least one FPGA configured according to configuration information. The configuration information may indicate subscribers to a market data publication service of the computing system and hardware interconnections within the at least one FPGA that facilitate publication of distribution messages containing filtered event data respectively to client devices of the subscribers permissioned to receive the distribution messages. The at least one FPGA may control: generating by the least one FPGA a distribution message containing filtered event data of an event for a client device of a subscriber permissioned to receive the filtered event data; routing the distribution message through the at least one FPGA; and transmitting the distribution message from the at least one FPGA to the client device. The at least one FPGA may include a feed generation circuit, a distribution and fanout circuit, and a plurality of message delivery circuits. A matching engine, a trading exchange, or like event source, as a computing device, may cause transmission to the feed generation circuit of an event message including the event data of the event and an event time for the event, where the event time is based on a time of a system clock of the computing system when the event message is transmitted to the feed generation circuit. The feed generation circuit may (i) based on filter information, generate distribution messages containing filtered event data of specific events respectively for one or more of the subscribers permissioned to receive the filtered event data of the specific events, and (ii) based on the configuration information, route the distribution messages respectively for the one or more subscribers in feeds to the distribution and fanout circuit. The distribution and fanout circuit may route distribution messages determined from the feeds respectively to the message delivery circuits, in accordance with the configuration information. The message delivery circuits may be communicatively coupled over communication paths respectively to client devices of subscribers permissioned to receive the distribution messages routed to the respective message delivery circuits. The distribution and fanout circuit may determine distribution times for respective distribution messages for a specific event, where a distribution time for a distribution message is based on the event time of the specific event, a hold delay for the distribution message, and a network latency offset for the distribution message. In addition, the distribution and fanout circuit may determine whether distribution times for respective distribution messages for the specific event are satisfied, based on comparisons of a current time of the system clock with the distribution times. When a given distribution time for a given distribution message is determined to be satisfied, the distribution and fanout circuit may cause a given message delivery circuit, to which the given distribution message was routed, to transmit the given distribution message to a given client device that is coupled to the given message delivery circuit over a given communication path. In one embodiment, a network latency offset for a distribution message may include a propagation delay offset corresponding to a communication path extending from a message delivery circuit to the client device of the subscriber permissioned to receive the distribution message, and optionally a serialization offset corresponding to a byte size of filtered event data for an event in the distribution message.

It is to be understood that the features in accordance with the present disclosure may be applied to equalizing differences in network latencies associated with distribution of event data other than asset trading data from a computing system to respective client devices in applications requiring simultaneous or substantially simultaneous receipt of filtered event data of a same event at multiple client devices, such as, for example, real-time streaming of video or audio data, such as in interactive multi-player games, or event data from sensors, such as sensors in an internet of things (“IOT”) network including health device sensors, traffic device sensors, etc.

The present disclosure may be implemented using a combination of computer hardware and computer software to form a specialized machine capable of performing operations. Embodiments of the present disclosure may be performed utilizing a combination of central processing units (CPUs), physical memory, physical storage, electronic communication ports, electronic communication lines and other computer hardware. The computer software may include at least a computer operating system and specialized computer processes described herein.

In the present disclosure, certain specific details are set forth to provide a thorough understanding of various disclosed embodiments. However, one skilled in the relevant art will recognize that embodiments may be practiced without one or more of these specific details, or with other methods, components, etc. In other instances, well-known structures associated with an electronic trading system have not been shown or described in detail to avoid unnecessarily obscuring descriptions of the embodiments.

The aspects, features and advantages of the present disclosure will be appreciated when considered with reference to the following description of examples and accompanying figures. In describing the exemplary embodiments of the disclosure illustrated in the drawings, specific terminology will be used for the sake of clarity. However, the disclosure is not intended to be limited to the specific terms used.

### Example Systems

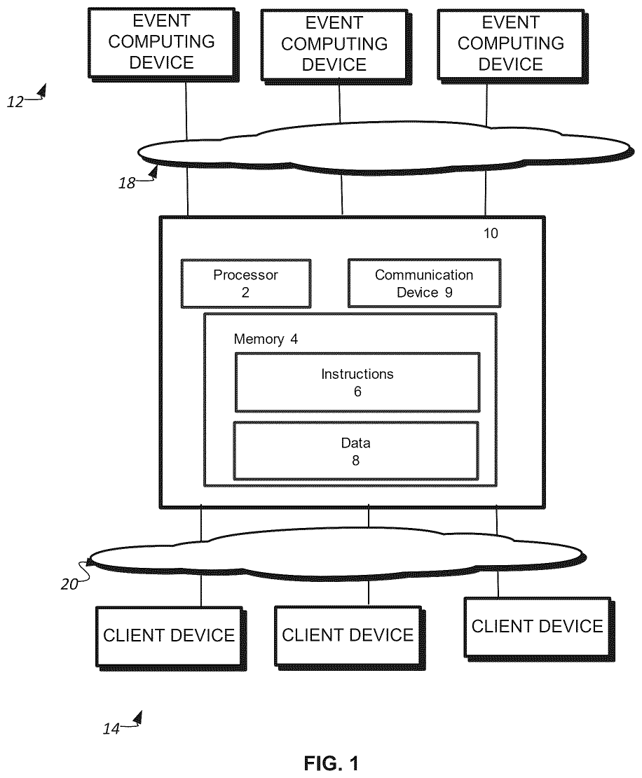

FIG. 1 illustrates a block diagram of an exemplary computing apparatus 10, in accordance with the present disclosure. The computing apparatus 10 may be communicatively coupled to a plurality of computing devices 12 as event sources (event computing devices), from which event data of an event may be transmitted to the computing apparatus 10. The event data may include, for example, order data describing an electronic trade executed at a computing device 12 serving as an electronic asset matching engine or trading exchange. In addition, the computing apparatus 10 may be communicatively coupled to a plurality of computing devices 14 (client devices) of respective users as subscribers to an event publication service of the computing apparatus 10. In one embodiment, the computing apparatus 10 may be configured to implement an event publication service that, based on filter information indicating event information of an event that may or may not be published to a specific subscriber as a permissioned user, causes each client device of a user permissioned to receive at least a portion of event data of a same event, to receive from the computing apparatus 10, at the same time or substantially the same time, at least a portion of the event data for the same event.

In accordance with the present disclosure, the computing apparatus 10 may perform processing functions that control distributing filtered event data of a same event for receipt at the same or substantially the same time respectively at a plurality of computing devices 14 of respective permissioned users, by equalizing differences in network latencies associated with transmitting distribution messages containing respective filtered event data for the same event from the computing apparatus 10 over respective communication paths to the computing devices 14, that advantageously facilitates receipt, processing, and distribution of event data of a same event with low latency and minimizes usage of communication network bandwidth, processing, and memory resources, as described in detail below.

Referring to FIG. 1, the computing apparatus 10 may be in the form of a computing device that includes one or more processors 2, one or more memory 4, and other components commonly found in computing devices. In one embodiment, the one or more processors 2 may include or be configured to operate as one or more servers.

The memory 4 may store information accessible by the one or more processors 2, including instructions 6 that may be executed by the one or more processors 2.

The one or more processors 2 may include an architecture configured to include a programmable hardware device, programmable integrated circuit, or reprogrammable logic device, such as a field programmable field array (“FPGA”), an application specific integrated circuit (“ASIC”), or system on chip (“SoCs”). In one embodiment, the architecture may be hardwired on a substrate. In one embodiment, the one or more processors 2 may include any type of processor, such as a CPU from Intel, AMD, and Apple.

Memory 4 may also include data 8 that can be stored, manipulated or retrieved by the processor. The data 8 may also be used for executing the instructions 6 and/or for performing other functions. The memory 4 may be any type of non-transitory media readable by the one or more processors, such as a hard-drive, solid state hard-drive, memory card, ROM, RAM, DVD, CD-ROM, write-capable, read-only memories, etc.

The instructions 6 may be any set of instructions capable of being read and executed by the one or more processors 2. The instructions may be stored in a location separate from the computing device, such as in a network attached storage drive, or locally at the computing device. The terms “instructions,” “functions,” “application,” “steps,” and “programs” may be used interchangeably herein. The instructions residing in a non-transitory memory may comprise any set of instructions to be executed directly (such as machine code) or indirectly (such as scripts) by processor 2. In this regard, the terms “instructions,” “scripts,” or “modules” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

Data 8 may be stored, retrieved and/or modified by the one or more processors 2 in accordance with the instructions 6. Such data may be stored in one or more formats or structures, such as in a relational or non-relational database, in a SQL database, as a table having many different fields and records, XLS, TXT, or XML documents. The data may also be formatted in any computing device-readable format. In some embodiments the data may be encrypted.

The apparatus 10 may include a communication device 9 configured to provide wired or wireless communication capabilities.

Referring to FIG. 1, in one embodiment, the computing apparatus 10 may be communicably interconnected with the computing devices 12 as matching engines or trading exchanges over a communication network 18, and the computing devices 14 of respective subscribers over a communication network 20. The communication network 18 may be a local area network (“LAN”), a wide area network (“WAN”), or the Internet, etc. The communication network 18 and intervening nodes thereof may use various protocols including virtual private networks, local Ethernet networks, private networks using communication protocols proprietary to one or more companies, cellular and wireless networks, HTTP, and various combinations of the foregoing. The communication network 20 may be a communication network having predetermined network characteristics, such as bandwidth, communication protocol, communication paths and communication path lengths, and include a local area network (“LAN”), wide area network (“WAN”), virtual private network, local Ethernet network, a private network using a proprietary communication protocol proprietary or like network. In addition, the networks 18 and 20 may utilize a variety of networking protocols now available or later developed including, but not limited to, Transmission Control Protocol/Internet Protocol (TCP/IP) based networking protocols.

In one embodiment, the computing apparatus 10 may include a portion of the communication network 18, the communication network 20, one or more of the computing devices 12, and/or one or more of the computing devices 14. In one embodiment, the computing device 12 may include or be coupled to circuitry (an event circuit) from which an event message including event data for an event occurring at or reported to the computing device 12 is transmitted over the communication network 18 to a component of the apparatus 10.

FIG. 1 illustrates the components of the computing apparatus 10 as being single components, however, the components may comprise multiple programmable hardware devices such as FPGAs, processors, computers, computing devices, or memories that may or may not be stored within the same physical housing. For example, the memory may be a hard drive or other storage media located in housings different from that of the computing apparatus 10. Accordingly, references to a programmable hardware device, processor, computer, computing device, or memory herein will be understood to include references to a collection of processors, computers, computing devices, or memories that may or may not operate in parallel. Further, although some functions described below are indicated as taking place on a single computing device having a single processor, various aspects of the subject matter described herein may be implemented by a plurality of computing devices in series or in parallel. For example, in one embodiment, functions performed by the computing apparatus 10 as described below may at least be partially performed at another computing apparatus having the same or similar components as the computing apparatus 10. In one embodiment, functions described herein as performed by the computing apparatus 10 may be distributed among one or more computing devices (servers) that operate as a cloud system.

Although only a single computing apparatus 10 (computer) is depicted herein, it should be appreciated that a computing apparatus in accordance with the present disclosure may include additional interconnected computers and reprogrammable hardware devices, such as FPGAs. It should further be appreciated that computing apparatus 10 may be an individual node in a network containing a larger number of computers.

In one embodiment, the computing apparatus 10 may include all the components normally used in connection with a computer. For example, computing apparatus 10 may have a keyboard and mouse and/or various other types of input devices such as pen-inputs, joysticks, buttons, touch screens, etc., as well as a display, which could include, for instance, a CRT, LCD, plasma screen monitor, TV, projector, etc.

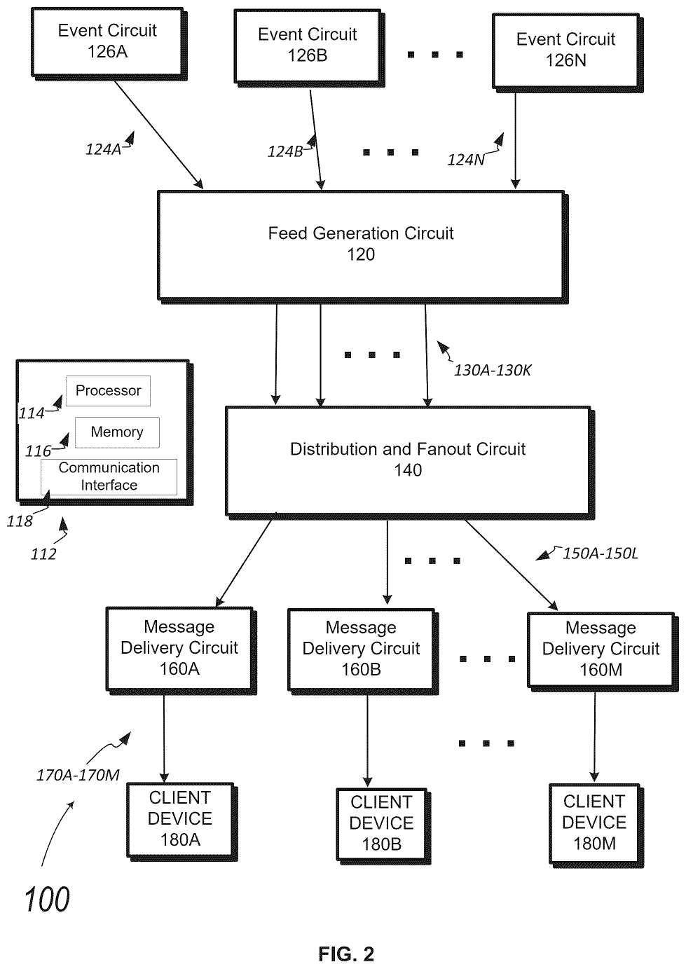

Referring to FIG. 2, in some embodiments, the computing apparatus 10 may be configured as a system 100 to implement specific functions and operations in accordance with the present disclosure. In some embodiments, the system 100 may be programmed with programs to perform some or all of the functions and operations described herein.

Referring to FIG. 2, the system 100 may include a server 112 including a processor 114, a memory 116, and a communication interface 118. The memory 116 may be configured to store instructions to implement specific functions and operations, and data related to event data processing and distribution, in accordance with the present disclosure. The communication interface 118 may include components that provide network communication capabilities. In one embodiment, each of the components of the system 100 may include a processor and a memory including instructions that implement functions of the respective component, as described below.

For ease of reference and convenience, the disclosure herein that the server 112 or another component of the system 100 may perform a function or operation, is a disclosure that a processor or circuitry of the server 112 or the another component of the system 100 may perform or control the performance of the function or operation.

The system 100 may include a feed generation circuit 120 configured as or to include an FPGA, a distribution and fanout circuit 140 configured as or to include an FPGA, and message delivery circuits 160 configured as or to include an FPGA. In one embodiment, specific functions and operations of the feed generation circuit 120, the distribution and fanout circuit 140, and the message delivery circuits 160, in accordance with the present disclosure, are desirably executed in a programmable hardware device, such as in an FPGA, although it is to be understood that some or all of the functions and operations may be executed in software.

The server 112 may be communicatively coupled with the feed generation circuit 120, the distribution and fanout circuit 140, and the message delivery circuits 160.

The server 112 may be communicatively coupled with event circuits 126A, 126B . . . 126N which are communicatively coupled with or included at least partially within respective event computing devices (not shown in FIG. 2). The system 100 may include communication paths 124A, 124B . . . 124N communicatively coupling the feed generation circuit 120 respectively to the event circuits 126A, 126B . . . 126N. The system 100 may include data paths 130A, 130B . . . 130K extending from the feed generation circuit 120 to the distribution and fanout circuit 140. In addition, the system 100 may include data paths 150A, 150B . . . 150L extending from the distribution and fanout circuit 140 to message delivery circuits 160A, 160B . . . 160M. The message delivery circuits 160 may be coupled over communication paths 170A, 170B . . . 170M with computing devices 180A, 180B . . . 180M (client devices) of respective users as subscribers to an event publication service of the system 100. Each message delivery circuit 160 may be communicatively coupled over a communication path 170 to a single client device 180.

In one embodiment, the system 100 may include the feed generation circuit 120, the data paths 130, the distribution and fanout circuit 140, the data paths 150, and the message delivery circuits 160 configured as an FPGA. The memory 116 may store configuration information for the system 100. The data paths 130, the data paths 150, and the message delivery circuits 160 may be interconnected with one another within the FPGA, according to the configuration information. The configuration information may indicate information on client devices 180 of respective subscribers to the event publication service; interconnections among the data paths 130, the data paths 150, and the message delivery circuits 160 within the FPGA; and specific client devices 180 of respective subscribers which are coupled over communication paths 170 respectively to the message delivery circuits 160. Based on the configuration information, in operation of the system 100, a distribution message for a given client device 180 may be routed over a predetermined data path 130 and a predetermined data path 150 to a predetermined message delivery circuit 160, which transmits the distribution message only to the given client device 180.

In one embodiment, each communication path 170 may be a communication path independent of any other communication path 170. In one embodiment, the system 100 may include at least a portion of one or more of the communication paths 170.

In one embodiment, the server 112 may be communicatively coupled with the computing devices 180.

In one embodiment, the system 100 may include a plurality of feed generation circuits 120 of respective FPGAs coupled over data paths 130, to a single distribution and fanout circuit 140 of an FPGA.

In one embodiment, one or more of the computing devices 180 may be a laptop, desktop or mobile computing device, such as a smartphone or tablet. The one or more client devices may execute an “app” to interact with the system 100. The app, for example, may execute on a mobile device operating system, such as Apple Inc.'s iOS®, Google Inc.'s Android®, or Microsoft Inc.'s Windows 10 Mobile®, which provides a platform that allows the app to communicate with particular hardware and software components of the mobile device. For example, the mobile device operating system may provide functionalities for interacting with location services circuitry, wired and wireless network interfaces, user contacts, and other applications, where the functionalities include application programming interfaces (APIs) that enable communication with hardware and software modules executing outside of the app, such as included in the system 100. In one embodiment, a computing device 180 may, via the app executing on the computing device 180, be configured to communicate with the system 100 via the communication interface 118.

Each event circuit 126 may have communication capabilities and be configured to generate an event message containing event data of an event. The event data may be generated at a matching engine or trading exchange, such as an event computing device 12 as described with reference to FIG. 1, associated with or including an event circuit 126. For example, the event may be a trade of an asset between first and second parties, and the event data of the event may include information identifying the asset, the first and second parties to the trade, the price of the asset in the trade, the size of the asset in the trade, and a trading exchange at which the trade was executed. An event circuit 126 may be configured to transmit an event message containing event data of an event to the feed generation circuit 120, and include in the event message an event time for the event, where the event time corresponds to a time when the event message is transmitted from the event circuit 126.

In one embodiment, a server 112 may be configured to include and control an electronic clock as a system clock of the system 100 that electronically times at increments of nanoseconds. Each event circuit 126 may be supplied with a current time of the system clock from the server 112. An event circuit 126 may determine an event time of an event message, based on a time of the system clock when the event message is transmitted.

In one embodiment, an event circuit 126, or an event computing device associated with the event circuit 126, may include and operate a local electronic clock whose time is based on or corresponds to a time of the system clock of the system 100. In one embodiment, the time of the local electronic clock may be synchronized with the time of the system clock of the system 100. In one embodiment, the event time for an event may be determined based on a time of the local electronic clock when an event message indicating the event is transmitted from an event circuit 126.

In one embodiment, an event circuit 126 may set an event time for an event as the time of the system clock, or the time of a local clock thereof, when a last data byte of event data in an event message is transmitted from the event circuit. In one embodiment, the event circuit may include the event time in a data packet of the event message, such as in a data packet of a header of the event message, or in a data packet in a payload of the event message.

As discussed below, the system 100 may utilize the current time of the system clock to control distribution of event data of a same event to multiple client devices based on the event time of the same event, with equalization of network latencies associated with transmission of distribution messages containing filtered event data of the same event to the respective client devices.

In one embodiment, an event message may have a Transmission Control Protocol (TCP), User Datagram Protocol (UDP), unicast, or multicast message format. For example, an event circuit 126 may be a TCP circuit that generates and transmits an event stream containing a plurality of event messages, such as a TCP stream of event messages.

The feed generation circuit 120 may, for a specific event received in an event message, based on filter information, generate a distribution message containing at least some portion of event data of the specific event, for at least one client device 180 respectively of at least one user permissioned to receive at least some portion of the event data of the specific event. The filter information, for example, may identify one or more users permissioned or not permissioned to receive certain event data describing a specific event or type of event. In one embodiment, a distribution message may include filtered event data, which is all or a portion of event data of an event, for at least one specific client device of at least one user permissioned to receive the filtered event data. For example, when the filter information indicates a user is permissioned to receive all event data of any event, a distribution message for the user may include, as the filtered event data of an event, all event data of the event received in an event message. The feed generation circuit 120 may generate a plurality of distribution messages for a specific event respectively for a plurality of client devices of respective permissioned users.

In one embodiment, a distribution message may include an event time of the event corresponding to the distribution message. In one embodiment, the event time of the event may be included as metadata in a distribution message for the event.

In one embodiment, the feed generation circuit 120 may generate, for a given distribution message, distribution information indicating one or more client devices respectively of one or more users permissioned to receive specific filtered event data for a specific event contained in the given distribution message.

In an exemplary operation of the system 100, subscribers A and B may subscribe to a market data publication service of the system 100, to receive market data on events related to equities from the system 100. Filter information for the market data publication service may indicate subscriber A can receive information for a specific equity and subscriber B cannot receive information for the specific equity. The feed generation circuit 120 may determine, based on the filter information, for an event that is a new order for the specific equity, (i) filtered event data for subscriber A that includes all event data of the new order for the specific equity, namely, the new order for the specific equity including price and size information, and (ii) that filtered event data for the event that is the new order for the specific equity is not created for subscriber B. In this example, the feed generation circuit 120 may generate a distribution message for subscriber A including the filtered event data for the new order determined therefor, and not generate a distribution message for subscriber B based on the event of the new order for the specific equity.

In one embodiment, the filter information may be based on input information received by the system 100, such as from a client device 180 of a subscriber, or publication restriction information included in an event message from an event circuit 126. In one embodiment, the filter information may be stored in the memory 116, such as in a lookup table.

In one embodiment, the feed generation circuit 120 may, for a specific event received in an event message, determine a current time of the system clock when the event message is received (“event receipt time”) at the feed generation circuit 120. The feed generation circuit 120 may store in the memory 116, for each event received in an event message, an event receipt time. As discussed in detail below, in an embodiment where a system similar to the system 100 includes a plurality of feed generation circuits 120, the event receipt time for a specific event may be used to order distribution messages for respective events in a queue, which is used to control transmission of the distribution messages to client devices respectively of permissioned users.

The feed generation circuit 120 may, for one or more client devices respectively of one or more users, generate a feed of distribution messages for respective events, according to the configuration information. Each feed may be for routing distribution messages that are for transmission only to one or more specific client devices. The distribution messages routed in a specific feed may include only filtered event data that a specific user or users for the specific feed is permissioned to receive, based on the filter information.

The feed generation circuit 120, based on the configuration information, may route feeds of distribution messages respectively for client devices 180 of permissioned users over data paths 130A, 130B . . . 130K to the distribution and fanout circuit 140.

The distribution and fanout circuit 140 may receive feeds of distribution messages routed over data paths 130A, 130B . . . 130K from the feed generation circuit 120. In addition, the distribution and fanout circuit 140 may, based on distribution messages on the feeds from data paths 130A, 130B . . . 130K, route distribution messages over data paths 150A, 150B . . . 150L to message delivery circuits 160A, 160B . . . 160M, in accordance with the configuration information.

A message delivery circuit 160 may include network communication capabilities and be configured to transmit a distribution message over a communication path 170 to a client device 180. A message delivery circuit 160 may transmit a distribution message received over a data path 150 only to a client device 180 to which a communication path 170 extends from the message delivery circuit 160, according to the configuration information. For example, the message delivery circuit 160A may transmit a distribution message routed on a feed A over data path 130A and received over the data path 150A, only to a client device 180A over the communication path 170A. In addition, the message delivery circuits 160C, 160D, and 160E may transmit distribution messages routed on a feed C on data path 130C and received over the data paths 150C, 150D, and 150E respectively, only to client devices 180C, 180D, and 180E over the communication paths 170C, 170D, and 170E.

In an example of operation of the system 100 in accordance with the configuration information, the distribution and fanout circuit 140 may route a first distribution message of feed A on the data path 130A over the data path 150A to the message delivery circuit 160A, such that the message delivery circuit 160A may transmit the first distribution message from the feed A only to the client device 180A. In another example of operation the system 100 in accordance with the configuration information, the distribution and fanout circuit 140 may, based on a second distribution message in a feed C routed on a data path 130C, route, by fanout over the data paths 150C, 150D, and 150E, second distribution messages that are identical replicas of the second distribution message in the feed C respectively to the message delivery circuits 160C, 160D, and 160E, such that the message delivery circuits 160C, 160D, and 160E may transmit the second distribution messages, routed thereto over the data paths 150C, 150D, and 150E, respectively only to the client devices 180C, 180D, and 180E. Thus, according to the configuration information, a single (same) distribution message, which is for client devices of respective multiple permissioned subscribers, may be routed in a feed and then replicated, and the replicated distribution messages may be routed by fanout to message delivery circuits that respectively are for transmitting the distribution messages only to specific client devices. For purposes of this disclosure, a given distribution message and each distribution message that is replica of the given distribution message are considered to be a same distribution message, in that each of the given distribution and the replica distribution messages contains the same filtered event data for an event and optionally the event time for the event.

The distribution and fanout circuit 140 may be configured to determine, for each event indicated in distribution messages received at the distribution and fanout circuit 140, distribution times respectively for distribution messages for the event. Distribution times for respective distribution messages for a same event may be determined to provide that each distribution message containing filtered event data for a same event is received from the system 100 at a same or substantially the same time at each computing device 180 of a user permissioned to receive filtered event data of the same event.

In one embodiment, distribution times for distribution messages may be determined to equalize differences in network latencies associated with transmission of distribution messages including filtered event data for the same event from respective message delivery circuits 160, over communication paths 170, to client devices 180. The distribution times of respective distribution messages may be based on network latency offsets including propagation delay offsets and optionally serialization offsets.

In one embodiment, the communication paths 170 may constitute a high-speed signal transmission medium, such as optical fiber, electrical cable or the like. The communication paths 170 may have predetermined network properties, which are based on a type of transmission medium of the communication path, and different communication protocols may be used to transmit signals on respective communication paths. The network properties and length of a predetermined communication path, and a communication protocol used to transmit a data signal, such as a distribution message containing filtered event data, along the communication path, may determine a propagation delay associated with transmitting the distribution message from a message delivery circuit 160 over a communication path 170 to a respective client device 180. Differences in the network properties and lengths of the respective communication paths 170, and communication protocols used to transmit data signals on the respective communication paths 170, may result in different propagation delays for the respective communication paths 170 extending from the message delivery circuits 160 to respective client devices 180. For example, distribution messages for a same event for subscribers A and B that are users respectively of client devices 180A and 180B may contain the same filtered event data, which is of the same byte size. In the circumstance that the distribution messages for subscribers A and B are transmitted at a same time from respective message delivery circuits 160A and 160B, without equalizing any propagation delay differences associated with respective communication paths 170A and 170B, one distribution message with the same filtered event data may be received at one of the client devices 180A and 180B at a different time than the other distribution message with the same filtered event data is received at another of the client devices 180A and 180B, based on the communication paths 170A and 170B interconnecting the respective message delivery circuits with the client devices having different lengths, for example, optical fiber cables having different lengths.

In one embodiment, the memory 116 may include communication path information indicating characteristics of a predetermined communication path that extends from a specific message delivery circuit over a predetermined communication path 170 to a predetermined client device 180 of a subscriber. The processor 114 may, based on the communication path information, determine a propagation delay offset associated with transmission of a distribution message from a specific message delivery circuit 160 to a specific client device 180. A propagation delay offset may be determined as a time difference between a time of transmission of a distribution message from the computing system, such as from a message delivery circuit 160, over a communication path 170, to a client device 180, and a time the distribution message is received at the client device 180.

For example, in an exemplary configuration of the system 100 where the same communication protocol is used to transmit distribution messages from each of the message delivery circuits 160, optical fiber is used as the medium of the communication paths 170, and different lengths of optical fiber as the communication paths 170 extend from the message delivery circuits 160 to respective computing devices 180, communication paths 170A and 170B extending respectively from message delivery circuits 160A and 160B to client devices 180A and 180B may be determined to have optical fiber lengths of 3 meters and 8 meters, such that propagation delay offsets for the client devices 180A and 180B may be −10 nsec and −26.7 nsec, respectively. The propagation delay offsets may be utilized to equalize differences in the propagation delays associated with communication paths 170 extending to respective client devices 180, to advantageously provide that filtered event data of, for example, a same asset trading event, may be received at a same or substantially the same time at the respective client devices 180.

In one embodiment, a length of an optical fiber cable extending from a message delivery circuit to a client device may be measured by electronic, optical or manual techniques, for example, by a tape measure, and the propagation delay offset for the client device may be determined based on the measured length of an optical fiber cable extending from the message delivery circuit to the client device.

The processor 114 may store in the memory 116 propagation delay offsets for communication paths 170 associated with respective message delivery circuits 160 and client devices 180.

In one embodiment, the distribution and fanout circuit 140 may determine a serialization offset for each distribution message for a specific event. Differences in serializations delays may exist for distribution messages of the same event, based on filtered event data for the same event having different byte sizes in respective distribution messages. The serialization offsets of respective distribution messages for a specific event may correspond to differences in byte sizes of filtered event data for the specific event. Advantageously, the serialization offsets for respective distribution messages for a same event may be determined and utilized by the system 100 to equalize differences in serialization delays associated with transmitting distribution messages by the message delivery circuits 160 respectively on to the communication paths 170.

In one embodiment, the distribution and fanout circuit 140 may determine, for each distribution message, a byte size of the distribution message, namely, a byte size of filtered event data of the distribution message and, when the distribution message includes data of an event time, a byte size of the data of the event time. The distribution and fanout circuit 140 may determine the byte size of a distribution message when the distribution message is received at the distribution and fanout circuit 140. The distribution and fanout circuit 140 may store a byte size for each distribution message in the memory 116.

In one embodiment, the feed generation circuit 120 may determine the byte size of a distribution message when the distribution message is generated at the feed generation circuit 120, and store the byte size for the distribution message in the memory 116.

For example, filtered event data for a same event contained in respective distribution messages for subscribers A and B, which are users of respective client devices 180A and 180B, may have byte sizes of 10 bytes and 100 bytes. In the example, assume all distribution messages generated by the system 100 have a same configuration, for example, a header followed by a payload that contains filtered event data, and that, when a distribution time for a distribution message is determined to be satisfied, a message delivery circuit 160 transmits a distribution message on to a communication path 170 at a ByteTransmission rate of 0.8 nsec/byte. If distribution messages having the different byte sizes of 10 and 100 bytes were to have the same distribution times, the entirety of the distribution message with the filtered event data for subscriber A may be transmitted before the entirety of the distribution message with the filtered event data for subscriber B. In the example, assuming that the propagation delay offsets are the same for the client devices 180A and 180B, in the absence of equalizing differences in serialization delays associated with transmission of the filtered event data in respective distribution messages from the system 100 to the client devices 180A and 180B, the entirety of the distribution message including filtered event data for the same event for subscriber A may be received at the client device 180A before the client device 180B receives all of the filtered event data for the same event for subscriber B. Hence, subscriber A may have an unfair advantage, because subscriber A receives, and thus may have available for use, information of the same event before subscriber B. In this circumstance, subscriber A can exploit the filtered event data of the event before subscriber B, for example, to submit an order to trade a financial instrument based on executed trade data indicated in the filtered event data, potentially to the detriment of the interests of subscriber B, who has an interest in trading the same financial instrument.

In one embodiment, serialization offsets for distribution messages for a same event may be determined to equalize differences in serialization delays, and provide that, for a same event, a last data byte of filtered event data for the same event in respective distribution messages transmitted from the system 100, may be received at the same or substantially the same time at respective client devices. In one embodiment, a serialization offset for a distribution message may be equal to a size in data bytes of the distribution message multiplied by a ByteTransmission rate at which the system 100 transmits a distribution message from a message delivery circuit 160 on to a communication path 170. In one example, the distribution message may include a header having a first data byte size and a payload having a second data byte size of the filtered event data. The serialization offset for a distribution message may be equal to: −(first data byte size of header+second data byte size of filtered event data in payload)*Bytetransmission rate. Returning to the prior example, assuming the size of the header is 5 data bytes and the Bytetransmission rate is 0.8 nsec/byte, the serialization offset for the distribution message for subscriber A may be −(5 bytes+10 bytes)(0.8 nesec/byte) or −12 nsec, and the serialization offset for the distribution message for subscriber B may be −(5 bytes+100 bytes)(0.8 nesec/byte) or −84 nsec.

In one embodiment, the feed generation circuit 120 or the distribution and fanout circuit 140 may determine, and store in the memory 116, serialization offsets respectively for distribution messages for a specific event.

In one embodiment, the network latency offsets used to determine distribution times for distribution messages for a specific event may include propagation delay offsets and not include serialization offsets, to provide that each client device of a permissioned user receives a first data byte of a distribution message containing filtered event data of the specific event, at a same or substantially the same time.

In one embodiment, the distribution and fanout circuit 140 may be configured to determine a distribution time for a distribution message that is equal to a sum of an event time for an event corresponding to filtered event data in the distribution message, a hold delay for the distribution message, and a network latency offset for the distribution message. The hold delay may be configurable for each specific feed of distribution messages routed from the feed generation circuit 120. For example, the hold delays for respective feeds of distribution messages routed on data paths 130A and 130B may be different. In another example, a hold delay may be the same for each of the feeds of distribution message routed on data paths 130. In one embodiment, a hold delay may be set to a value that allows the system 100 sufficient time to communicate a message providing details of an event, such as execution of a trade order, to a computing device of an entity that is a party to the trade order, before any filtered event data of the event, which is published in accordance with an event publication service of the system 100, is received at any client device 180. In one embodiment, a hold delay for a specific feed of distribution messages may be greater than an absolute value of a largest propagation delay offset for a client device 180 which is to receive the distribution messages of the specific feed, according to the configuration information. In one embodiment, a hold delay may be greater than an absolute value of a largest expected network latency offset for a distribution message that the system 100 may transmit. In one embodiment, a hold delay for each of the feeds routed from the feed generation circuit 120 may be about 40 microseconds.

The distribution and fanout circuit 140 may, continuously or at a preset time interval, determine a current time of the system clock, and compare a distribution time for a distribution message with the current time of the system clock. The distribution and fanout circuit 140 may determine that a distribution time is satisfied, when the current time of the system clock is the same as or after the distribution time. When the distribution time for a distribution message is determined to be satisfied, the distribution and fanout circuit 140 may cause transmission of the distribution message from a message delivery circuit 160.

A message delivery circuit 160 may have network communication capabilities and be configured to transmit a distribution message using a predetermined message format. In one embodiment, the transmission of a distribution message by a message delivery circuit 160 may include reading, from a memory in the FPGA, filtered event data of the distribution message received from the distribution and fanout circuit 140. In one embodiment, a message delivery circuit 160 may be configured to implement Internet Protocol (IP) multicast, for example, using a User Datagram Protocol (UDP), Unicast or any messaging protocol that may provide for data transmission of a distribution message to one or more computing devices 180. In one embodiment, a message delivery circuit 160 may transmit a distribution message in a message format required by a client device 180 to which the message delivery circuit 160 is coupled over a communication path 170, as indicated in the configuration information.

In one embodiment, a message delivery circuit 160 may be configured as or include a TCP server circuit. In one embodiment, a TCP server circuit may transmit a distribution message containing filtered event data in one or more TCP segments. In one embodiment, a distribution message may be transmitted using a binary market protocol format, such as Financial Information exchange (FIX®) protocol, or a multicast message format. In one embodiment, a communication path 170 between the message delivery circuit 160 and a computing device 180 may be configured to facilitate communication using a Point to Point FIX protocol, or any other protocol.

In one embodiment, a first distribution message for an event may be transmitted with a message format that is different from a message format of an event message from which filtered event data in the first distribution message is determined, and a second distribution message for the event may be transmitted with a message format that is the same as the message format of the event message from which filtered event data in the second distribution message is determined.

In one embodiment, each distribution message for an event may be transmitted with a message format that is different from a message format of an event message from which filtered event data in the distribution message is determined.

In one embodiment, distribution and fanout circuit 140 may be configured to generate a queue in a memory, such as the memory 116. The queue may representatively indicate events corresponding to the filtered event data in distribution messages received at the distribution and fanout circuit 140, and, for each event, each distribution message to be transmitted to a client device including a distribution time for the distribution message. The distribution and fanout circuit 140 may remove a distribution message from the queue, when the distribution time for the distribution message is determined to be satisfied.

For example, first event data of a first event from an event circuit 126A may have a first event time prior to a second event time of second event data of a second event from an event circuit 126B, where the first event time and the second event time correspond to a time of the system clock when the first event data and second event data are transmitted respectively from the event circuits 126A and 126B. Based on differences in the path lengths of the communication paths 124A and 124B, the feed generation circuit 120 may receive the second event data before the first event data. As a result, the distribution and fanout circuit 140 may receive, from the feed generation circuit 120, a distribution message containing second filtered event data of the second event data, before a distribution message containing first filtered event data of the first event data is received. Based on the event times indicated, for example, in the metadata of the distribution messages containing the first and second filtered event data, the distribution and fanout circuit 140 may have the queue list, in chronological order in accordance with the respective first and second event times, distribution messages for the first event followed by distribution messages for the second event.

In one embodiment, for each event in the queue, the distribution and fanout circuit 140 may be configured to order all the distribution messages for the event chronologically based on the distribution times respectively.

In one embodiment, the system 100 may be configured to operate in an event time priority mode for publication of events. In the event time priority mode, the distribution and fanout circuit 140 may in chronological order, for each event in the queue, determine whether a distribution time of a distribution message for the event is satisfied, based on comparison of the distribution time with a current time of the system clock. In addition, in the event time priority mode, the distribution and fanout circuit 140 may cause all distribution messages for a specific event in the queue to be transmitted from message delivery circuits 160, before any distribution message for another event chronologically next in the queue, in other words, having an event time next after the event time of the specific event, is caused to be transmitted from a message delivery circuit 160.

In one embodiment, the system 100 may be configured to operate in a distribution time priority mode for publication of events. In the distribution time priority mode, the distribution and fanout circuit 140 may cause distribution messages for respective events to be transmitted from message delivery circuits based on respective distribution times, without regard to whether all distribution messages for a specific event listed in the queue have been transmitted. For example, the queue may include distribution messages of a first event followed by distribution messages of a second event based on a first event time of the first event being earlier than a second event time of the second event, and a second distribution message for the second event in the queue may have a second distribution time earlier than a first distribution time for a first distribution message for the first event in the queue. As a result, the second distribution time may be determined to be satisfied before the first distribution time, such that the second distribution message is caused to be transmitted before the first distribution message. In other words, a distribution message for the second event is caused to be transmitted before all distribution messages for the first event are transmitted. This transmission sequence for the first and second distribution messages may occur, for example, based on the circumstance that there is a large difference between byte sizes of filtered event data respectively for the first and second distribution messages, or a large difference between propagation delay offsets for client devices respectively to which the first and second distribution messages are for transmission.

In one embodiment, the system 100 may operate in an event priority mode or a distribution time priority mode based on a default setting for the system 100, or based on an instruction, for example, received by the system 100 over a communication network from an external computing device.

In one embodiment, where two or more different events have a same event time, the distribution and fanout circuit 140 may order the different events, with their respective distribution messages, one immediately after another in the queue, chronologically based on event receipt times of the different events, assuming the event receipt times are different. In one embodiment, where two or more different events have a same event time and same event receipt time, the different events may be ordered in the queue chronologically based on a current time of the system clock when processing of a distribution message for a specific event received at the distribution and fanout circuit 140 commences. For example, when first and second events have a same event time and same event receipt time, and processing of any distribution message for a first event received at the distribution and fanout circuit 140 commences by the distribution and fanout circuit 140 before processing of any distribution message for a second event received at the distribution and fanout circuit 140 commences, the first event with its distribution messages is listed in the queue preceding the second event with its distribution messages.

In one embodiment, where two or more distribution messages for a same event are determined to have the same distribution times, the distribution and fanout circuit 140 may, for the same event, order the distribution messages one immediately after another in the queue, chronologically based on a current time of the system clock when processing of any of the two or more distribution message received at the distribution and fanout circuit 140 commences by the distribution and fanout circuit 140. For example, when first and second distribution messages for a same event have the same distribution times, and processing of the first distribution message for the same event commences by the distribution and fanout circuit 140 before processing of the second distribution message for the same event commences, the first distribution message is listed in the queue preceding the second distribution message.

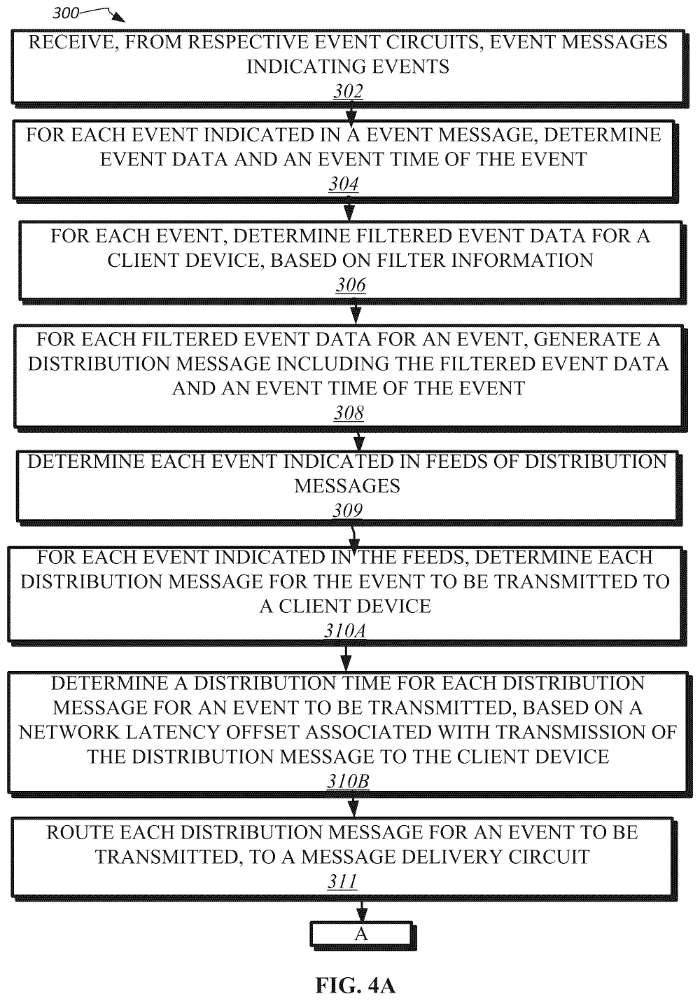

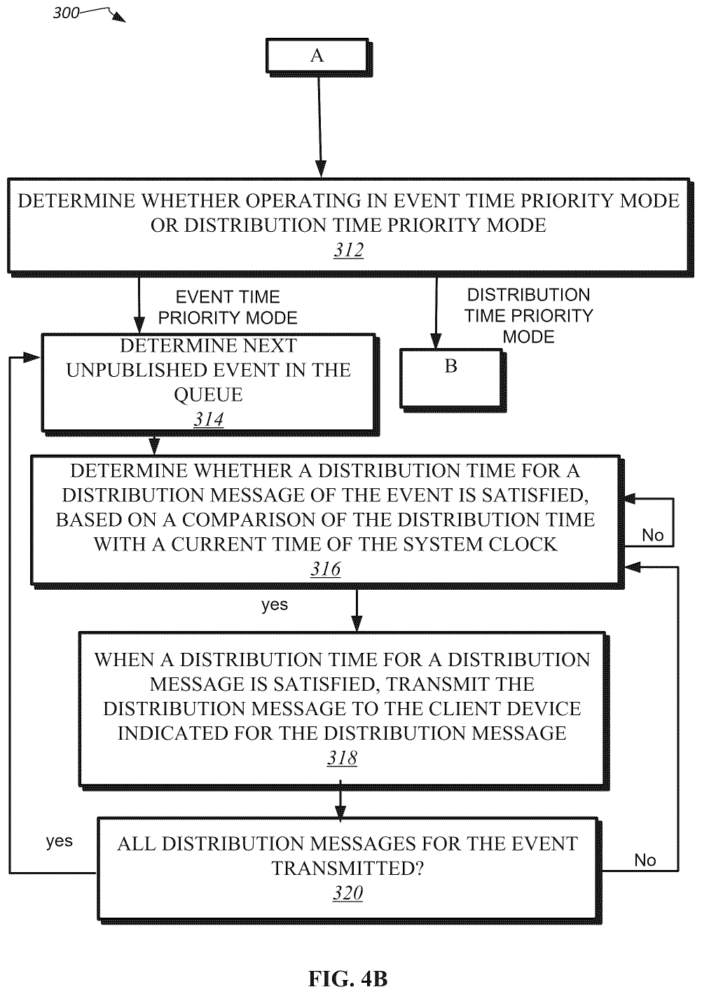

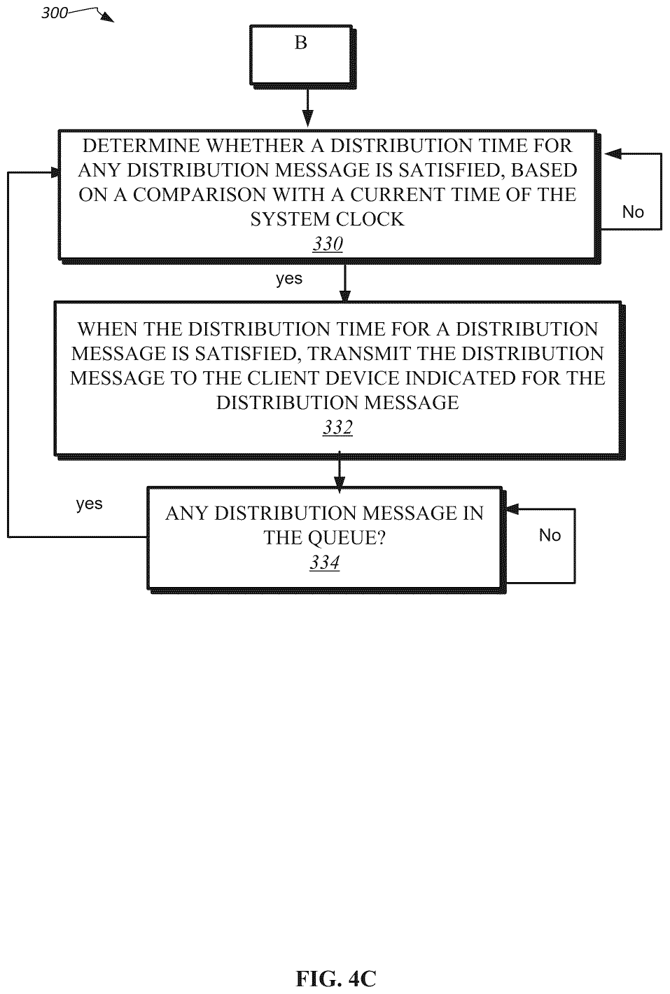

As discussed below in connection with FIGS. 4A, 4B and 4C, for a specific instance of a comparison of a current time of the system clock with distribution times of respective distribution messages in the queue, the distribution times of two or more distribution messages for a same event or a different event may be determined to be satisfied. For this comparison instance, when the two or more distribution messages are for respective different client devices, the distribution and fanout circuit 140 may cause simultaneous or substantially simultaneous transmission of the distribution messages from message delivery circuits 160 on to communication paths 170 respectively extending to the different client devices. For example, first and second distribution messages of the two or more distribution messages for a same event may be caused to be simultaneously or substantially simultaneously transmitted from message delivery circuits 160A and 160B respectively for receipt at different client devices 180A and 180B.

In one embodiment, the distribution times of two or more distribution messages for respective different events may be determined to be satisfied based on an instance of a comparison with a current time of the system clock. For this comparison instance, when at least two of the distribution messages are for the same client device, the distribution and fanout circuit 140 may cause successive transmission of the at least two of the distribution messages from a same message delivery circuit 160, in chronological order based on event times of the at least two of the distribution messages.

Advantageously in accordance with the present disclosure, in an exemplary operation of the system 100, the determination of the distribution times for distribution messages, based on propagation delay offsets and optionally serialization offsets, equalizes differences in network latencies associated with transmission of distribution messages with respective filtered event data from message delivery circuits over communication paths to client devices of permissioned users, and provides that information on an event, such as an executed trade generated at a matching engine or trading exchange, may be received at a same or substantially the same time at each client device of a user indicated by filter information as permissioned to receive at least some information describing the event.

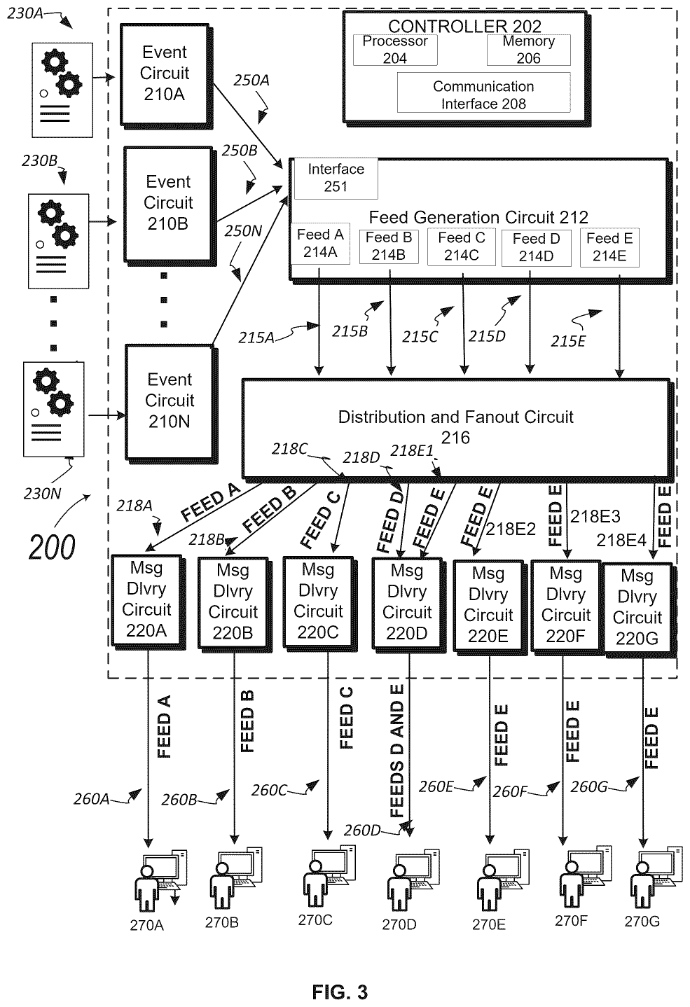

For purposes of highlighting and illustrating the features of the present disclosure, a system 200, as shown in FIG. 3, to implement specific functions and operations in accordance with the present disclosure is described below. The system 200 may be configured to implement an event publication service for market data events associated with asset trading. The market data events may be, for example, cancelation of an existing order or execution of a trade involving two orders, and include details of or relating to the order or trade, such as price, quantity, identity of a party that entered an order that was executed to generate a trade as an event, identification information of a trading exchange or matching engine as a computing device at which the event occurred, etc.

Referring to FIG. 3, the system 200 may include a controller 202 including at least one processor 204, a memory 206, and a communication interface 208. In addition, the system 200 may include event circuits 210A, 210B . . . 210N, communication paths 250A, 250B . . . 250N, a feed generation circuit 212 including feed ports 214A, 214B, 214C, 214D, and 214E, data paths 215A, 215B, 215C, 215D, and 215E, a distribution and fanout circuit 216, data paths 218A, 218B, 218C, 218D, 218E1, 218E2, 218E3, and 218E4, and message delivery circuits (“Msg Dlvry Circuits” in FIG. 3) 220A, 220B, 220C, 220D, 220E, 220F, and 220G. It is to be understood that the event circuits 210, communication paths 250, feed generation circuit 212, data paths 215, distribution and fanout circuit 216, data paths 218, and message delivery circuits 220 of the system 200 may have a same or similar construction and operation respectively as the event circuits 126, communication paths 124, feed generation circuit 120, data paths 130, distribution and fanout circuit 216, data paths 150, and message delivery circuits 160 described above in connection with the system 100. In addition, it is to be understood that the processor 204, memory 206, and communication interface 208 of the system 200, and the communication paths 260, may have a same or similar construction and operation respectively as the processor 114, memory 116, and communication interface 118, and the communication paths 170, described above in connection with the system 100.

In an exemplary embodiment of the system 200 as discussed herein, a single FPGA may be configured as the feed generation circuit 212, the data paths 215, the distribution and fanout circuit 216, the data paths 218, and the message delivery circuits 220 of the system 200. In addition, the single FPGA may include at least a portion of the memory 206. Configuration information for the system 200 may be stored in memory 206. Similarly as for the configuration information of the system 100, the configuration information for the system 200 may indicate interconnections among the data paths 215, the data paths 218, and the message delivery circuits 220 in the single FPGA which provide that distribution messages of specific feeds may be transmitted by message delivery circuits 220 respectively to one or more specific client devices of subscribers to a market data publication service of the system 200 permissioned to receive the distribution messages in the specific feeds. The subscribers may be, for example, traders or brokers.

The processor 204 may be communicatively coupled with and configured to control the feed generation circuit 212, the distribution and fanout circuit 216, and the message delivery circuits 220.

In one embodiment, the event circuits 210 may be communicatively coupled with and configured as part of respective computing devices 230. In one embodiment, a computing device 230 may include an event circuit 210. In addition, the controller 202 may be communicatively coupled with event circuits 210 and/or the computing devices 230.

In one embodiment, one or more of the computing devices 230 may be, for example, a financial venue or exchange, a matching engine, a financial trading clearinghouse, a credit check facility, or a financial trading compliance office.

The event circuits 210A, 210B . . . 210N may be communicatively coupled with the feed generation circuit 212 respectively over communication paths 250A, 250B . . . 250N. The feed generation circuit 212 may include a network interface 251 to which the communication paths 250A, 250B . . . 250N are coupled. The feed generation circuit 212 may include the feed ports 214 that are communicatively coupled over respective data paths 215 to the distribution and fanout circuit 216, in accordance with the configuration information for the system 200. Each data path 215 may route a specific feed of distribution messages to the distribution and fanout circuit 216 which are for transmission to at least one specific client device.

In one embodiment, in accordance with the configuration information for the system 200, the feed generation circuit 212 may route distinct feeds A, B, C, and D of distribution messages containing filtered event data of distinct events, from feed ports 214A, 214B, 214C, and 214D respectively over data paths 215A, 215B, 215C, and 215D. The distribution messages for a same event in the respective feeds A, B, C, and D may have different filtered event data and be for transmission to different subscribers at client devices 270A, 270B, 270C, and 270D.

In one embodiment, in accordance with the configuration information for the system 200, the feed generation circuit 212 may route on a single data path 215E, from a feed port 214E to the distribution and fanout circuit 216, a feed E of distribution messages for respective events, where each of the distribution messages in feed E is for receipt by a same plurality of client devices 270D, 270E, 270F, and 270G. In one embodiment, a distribution message for an event in feed E may include all event data of the event received by the system 200. In another embodiment, feed E may be for respective subscribers permissioned to receive all event data of a specific type or category of an event received by the system 200. In one embodiment, a distribution message in the feed D may be for a same event as a distribution message in the feed E and include only a portion of the event data for the same event, and the distribution message for the same event in the feed E may include all event data for the same event.

The distribution and fanout circuit 216 may be communicatively coupled over data paths 218A, 218B, 218C, and 218D respectively with message delivery circuits 220A, 220B, 220C, and 220D. In addition, the distribution and fanout circuit 216 may be communicatively coupled over data paths 218E1, 218E2, 218E3, and 218E4 with message delivery circuits 220D, 220E, 220F, and 220G, respectively.

In accordance with the configuration information for the system 200, the distribution and fanout circuit 216 may route distribution messages on feeds received from the feed generation circuit 212 on the data paths 215A, 215B, 215C, and 215D respectively over data paths 218A, 218B, 218C, and 218D to message delivery circuits 220A, 220B, 220C, and 220D. In addition, in accordance with the configuration information, the distribution and fanout circuit 216 may replicate a distribution message in the feed E on the data path 215E and route, by fanout, the distribution messages resulting from the replication of the distribution message in the feed E, over the data paths 218E1, 218E2, 218E3, and 218E4 respectively to the message delivery circuits 220D, 220E, 220F, and 220G for transmission respectively to the client devices 270D, 270E, 270F, and 270G.

In one embodiment, for a distribution message on a feed received at the distribution and fanout circuit 216 which is for transmission to a single client device, the distribution and fanout circuit 216 may route the distribution message from a data path 215, without delay, on to a data path 218 extending to a message delivery circuit 220 that is communicatively coupled to the single client device. For example, the distribution messages in the feeds A, B, C, and D on data paths 215A, 215B, 215C, and 215D may be routed, without delay, by the distribution and fanout circuit 216 respectively over data paths 218A, 218B, 218C, and 218D to the message delivery circuits 220A, 220B, 220C, and 220D.

In one embodiment, for a distribution message on a feed received at the distribution and fanout circuit 216 which is for transmission to multiple client devices, the distribution and fanout circuit 216 may simultaneously route, by fanout, distribution messages, which are replicas of the distribution message received at the distribution and fanout circuit 216, at a predetermined routing time for the distribution messages, on to data paths 218 extending to message delivery circuits 220 that are communicatively coupled respectively to the multiple client devices. The predetermined routing time may be based on a largest network latency offset among the network latency offsets associated with transmission of the distribution messages from the message delivery circuits 220 to the respective multiple client devices 270. In one embodiment, the predetermined routing time may be a sum of an event time for the distribution message on the feed received at the distribution and fanout circuit 216 which is for transmission to the multiple client devices, a hold delay for the distribution message on the feed, and a maximum network latency offset of the network latency offsets associated with transmission of the replica distribution messages respectively from the message delivery circuits 220. For example, the distribution and fanout circuit 216 may route four distribution messages, which are replicas of a distribution message in the feed E on data path 215E, simultaneously, at a predetermined routing time for the four distribution messages, over data paths 218E1, 218E2, 218E3, and 218E4 respectively to the message delivery circuits 220D, 220E, 220F, and 220G, when the distribution and fanout circuit 216 determines a current time of the system clock is equal to or after the predetermined routing time for the four distribution messages.

The message delivery circuits 220A, 220B, 220C, 220D, 220E, 220F, and 220G may be communicatively coupled over respective communication paths 260A, 260B, 260C, 260D, 260E, 260F, and 260G with client devices 270A, 270B, 270C, 270D, 270E, 270F, and 270G of subscribers. As the message delivery circuit 220D is communicatively coupled to data paths 218D and 218E1 on which distribution messages from feeds D and E may be routed, the client device 270D may receive distribution messages from the two different feeds D and E over the communication path 260D.

The distribution and fanout circuit 216 may cause transmission of distribution messages from message delivery circuits 220 to respective client devices 270, based on distribution times respectively of the distribution messages.

In one embodiment, the memory 206 may include a lookup table or equivalent that indicates, for each distribution message to be transmitted to a client device, a distribution time, a network latency offset, a propagation delay offset, a serialization offset, a message delivery circuit 220 for transmission of the distribution message, and a client device 270 to receive the distribution message. For example, the memory 206 may indicate that a distribution message for transmission from the message delivery circuit 220A to a client device 270A has a network latency offset of −19 nsec, a serialization offset of −10 nsec, and a propagation delay offset of −9 ns.

In one embodiment, the distribution and fanout circuit 216 may cause simultaneous transmission of distribution messages including filtered event data of a same event, from several message delivery circuits 220 to respective client devices 270. In one embodiment, the message delivery circuits 220 may be caused to transmit distribution messages for a same event over communication paths 260 at different times, in accordance with the distribution times thereof, to provide that respective filtered event data of the same event is received at a same or substantially the same time by respective client devices 270.

In one embodiment, the system 200 may include a plurality of feed generation circuits 212 as one or more of FPGAs that are coupled respectively to a plurality of event circuits 210. In this embodiment, each of the feed generation circuits 212 may route feeds of distribution messages therefrom over respective data paths 215 to the distribution and fanout circuit 216. The distribution and fanout circuit 216 may, based on distribution messages for events on the feeds from the feed generation circuits 212, route distribution messages to be transmitted for the events over data paths 218 to message delivery circuits 220, in accordance with the configuration information.

### Example Methods

For purposes of illustrating the features of the present disclosure, a high level block diagram of an exemplary process 300, as shown in FIGS. 4A, 4B and 4C, is described below in connection with operations performed at components of the system 200. The process 300 may publish at least some portion of event data of a same event to client devices of respective subscribers of an event publication service of the system 200, based on filter information indicating event information that may or may not be published to a specific subscriber, and advantageously equalizes difference in network latencies associated with transmission of distribution messages containing filtered event data of the same event over communication paths respectively to the client devices, to provide that filtered event data of the same event is received at a same or substantially the same time at the client devices of respective subscribers permissioned to receive the filtered event data.

In an exemplary embodiment of the system 200, the process 300 may control: receiving event messages from respective computing devices, where each event message indicates an event and an event time of the event, and where the event time corresponds to a time of a system clock of the system 200 when the event message is transmitted to the system 200; determining, for each event, event data and the event time; generating, based on filter information, one or more distribution messages for a specific event for one or more client devices of one or more subscribers permissioned to receive at least some event data of the event; determining, for each distribution message to be transmitted to a specific client device for a specific event, a distribution time that equalizes any differences in network latencies associated with transmission of filtered event data of the specific event in distribution messages over communication paths respectively to client devices of respective subscribers permissioned to receive the distribution messages; determining when a distribution time for a distribution message is satisfied, by comparing the distribution time with a current time of the system clock; and, when the distribution time for a distribution message is determined to be satisfied, causing transmission of the distribution message to the client device indicated for receipt of the distribution message. As discussed in detail below, the distribution time for each distribution message to be transmitted for a specific event is determined, according to the present disclosure, to advantageously provide that filtered event data of a specific event may be received from the system 200 at a same or substantially the same time, at client devices of respective subscribers permissioned to receive filtered event data of the specific event as a publication of the specific event.

Referring to FIGS. 3, 4A, 4B and 4C, in block 302, a computing device 230 associated with an event circuit 210 may, automatically, or at least partially in response to an input from another computing device or a human, generate event data representative of occurrence of an event. An event may be, for example, an order state including cancelation of an existing trade order for an asset, matching or execution of a trade order for an asset of a first party with a trade order for an asset of a second party, receipt of a new trade order for an asset, receipt of a change to an existing trade order, such as to price or size, etc. The event data may include asset trade data including, for example, price, quantity, orientation (buy or sell), identifier of an asset, such as an equity, U.S. treasury bond, or intangible asset, such as cryptocurrency, identifier of each party involved in a trading related event, and a time that the event occurred, such as a time a revision to an order was received or was completed, or a time that a trade involving two orders was matched or executed.

In addition, in block 302 the computing device 230 may, based on occurrence of an event, automatically control the event circuit 210 to generate, and transmit over a communication path 250 to the feed generation circuit 212, an event message including the event data of the event and an event time of the event. The event time may be based on a time of a local clock of the event circuit 210 when the event circuit 210 transmits an event message including the event data of the event, based on an instruction received from the computing device 230. Similarly as discussed above for the system 100, a time of the local clock of an event circuit may be based on, and desirably synchronized with, a time of the system clock of the system 200.

In one embodiment, a computing device 230 or an event circuit 210 associated with a computing device, such as the computing device 230A and associated event circuit 210A, may store in a memory of the computing device 230 or the event circuit 210, the event time of a specific event contained in an event message transmitted from an event circuit.

Further in block 302, the feed generation circuit 212 may receive, over communication paths 250 via network interface 251, a plurality of event messages containing event data of respective events from the event circuits 210.

For purposes of illustrating features of the process 300 implemented with the system 200, the following example of events indicated in event messages transmitted from event circuits 210 over communication paths 250 and received at the feed generation circuit 212 is referred to below. In the example, the feed generation circuit 212 receives, over the communication paths 250A, 250B, 250C, and 250D, event messages transmitted from event circuits 210A, 210B, 210C, and 210D, respectively indicating Event-1, Event-2, Event-3, and Event-4, where each event describes an electronic asset trading event. The event times of Event-1, Event-2, Event-3, and Event-4 are times of the system clock of the system 200 respectively when the event messages indicating Event-1, Event-2, Event-3, and Event-4 are transmitted, where Event-1 has an event time T1, Event-2 has an event time T2, T2=T1+Delta 1 and Delta 1 is a positive value, Event-3 has an event time T3, T3=T1+Delta 2, and Delta 2>Delta 1, and Event-4 has an event time T4, T4=T1+Delta 3, and Delta 3>Delta 2.

In one embodiment, in block 302, the feed generation 212 may determine, for each event message received at the feed generation circuit 212, such as at the network interface 251, an event receipt time, which is a current time of the system clock when the event message is received at the network interface 251.

In block 304, the feed generation circuit 212 may, by extracting data from each event message received at the feed generation circuit 212, identify an event indicated in the event message. In addition, in block 304, also by extracting data from an event message, the feed generation circuit 212 may, for each event identified, determine event data of the event and the event time for the event.

In one embodiment, the feed generation circuit 212 may store in the memory 206, for a specific event, event data and an event time for the specific event which are included in an event message indicating the specific event. In one embodiment, the feed generation circuit 212 may store in the memory 206, for each specific event, an event receipt time of the event message indicating the specific event, based on the determination of the event receipt time in block 302.

In one embodiment, an event message may contain permission-related information indicating an identity of a subscriber that is or is not permissioned to receive certain event data of an event, such as an event indicated in the event message or a different event not indicated in the event message. In addition, the permission-related information may indicate a characteristic, type, or component of event data of an event that a subscriber is or is not permissioned to receive. The feed generation circuit 212 may extract this permission-related information from an event message, and store the permission-related information as filter information in the memory 206.

In block 306, for each event in an event message received at the feed generation circuit 212, the feed generation circuit 212 may, based on filter information, determine filtered event data from the event data of the event and distribution information for the filtered event data. The distribution information for the filtered event data may indicate one or more client devices of one or more subscribers permissioned to receive the filtered event data for a specific event. In one embodiment, the distribution information may indicate a specific subscriber(s) that, based on the filter information, is permissioned to receive certain event data of an event as filtered event data.

In one embodiment, the memory 206 may include filter information indicating an identity of a subscriber of the system 200 that is or is not permissioned to receive certain event data of a specific event, and a characteristic, type, or component of the event data that the subscriber can or cannot receive. For example, the filter information may indicate that a subscriber is not permitted to receive certain event data, such as the identity of the parties to an executed trade as the event, unless the subscriber is affiliated with a party to the executed trade.

For example, for an event involving an executed trade between parties C and D, where subscriber A is affiliated with the party C and subscriber B is not affiliated with either of the parties C and D, based on the filter information, subscriber A may receive order data identifying parties C and D as the parties of the executed trade, along with the trade price and name of the equity of the executed trade, whereas subscriber B may only receive a portion of the order data, namely, information indicating the trade price and name of the equity of the executed trade without the identities of the parties of the executed trade. The filter information may provide that all or a portion of the event data of the event in the event message is the filtered event data for a specific subscriber. Accordingly, filtered event data for a same event for client devices of respective users may be different and vary in byte size in distribution messages, based on the filter information.

In block 308, for each filtered event data determined for an event, the feed generation circuit 212 may generate a distribution message. The distribution message may include the filtered event data, and an event time of the event. In one embodiment, the event time may be included as metadata of the distribution message.

For example, an event message received at the system 200 may include trade data of a trade completed based on orders from subscriber A and subscriber B, and filter information in the memory 206 may indicate that subscriber A is not notified of a counterparty for a completed trade where the counterparty is subscriber B. Based on the trade data contained in the event message and the filter information, a first distribution message may be generated for a client device 270A of subscriber A and include filtered event data indicating various details of the trade and identifying only party A as a party of the completed trade; and a second distribution message may be generated for a client device 270B of subscriber B and include filtered event data indicating various details of the trade and identifying both subscriber A and subscriber B as parties of the completed trade.

Further, in block 308, the feed generation circuit 212 may generate multiple feeds for routing distribution messages for respective client devices 270. For example, the feed generation circuit 212 may generate distinct distribution messages for an event for respective client devices, where each distribution message includes a different portion of the event data for a same event as the filtered event data. Based on the configuration information and one or more client devices indicated in the distribution information for distribution messages, the feed generation circuit 212 may route the distribution messages for respective different client devices in individual distinct feeds on respective data paths 215.

Referring to FIG. 3, the feed generation circuit 212 may route distribution messages having different filtered event data for a same event and respectively which are for different client devices 270A, 270B, 270C, and 270D, in feeds A, B, C, and D from feed ports 214A, 214B, 214C, and 214D respectively over data paths 215A, 215B, 215C, and 215D to the distribution and fanout circuit 216. In addition, the feed generation circuit 212 may route a single distribution message for an event, which is for client devices 270D, 270E, 270F, and 270G, in feed E from feed port 214E over data path 215E to the distribution and fanout circuit 216. A distribution message in the feed E, for example, may include all event data for an event.

Continuing with the example of Event-1, Event-2, Event-3, and Event-4, the feed generation circuit 212 may, based on filter information, generate: Distribution Message 1 including filtered event data 1A of Event-1 and metadata indicating an event time T1, and distribution information indicating Distribution Message 1 is for client device 270A; Distribution Message 2 including filtered event data 1B of Event-1 and metadata indicating an event time T1, and distribution information indicating Distribution Message 2 is for client device 270B; Distribution Message 3 including filtered event data 1C of Event-1 and metadata indicating an event time T1, and distribution information indicating Distribution Message 3 is for client device 270C; Distribution Message 4 including filtered event data 2A of Event-2 and metadata indicating an event time T2, and distribution information indicating Distribution Message 4 is for client device 270A; Distribution Message 5 including filtered event data 2B of Event-2 and metadata indicating an event time T2, and distribution information indicating Distribution Message 5 is for client device 270B; Distribution Message 6 including filtered event data 2C of Event-2 and event time T2, and distribution information indicating Distribution Message 6 is for client device 270C; Distribution Message 7 including filtered event data 3A of Event-3 and metadata indicating an event time T3, and distribution information indicating Distribution Message 7 is for client device 270A; Distribution Message 8 including filtered event data 3B of Event-3 and metadata indicating an event time T3, distribution information indicating Distribution Message 8 is for client device 270B; and Distribution Message 9 including filtered event data 3C of Event-3 and metadata indicating an event time T3, and distribution information indicating Distribution Message 9 is for client device 270C. Based on the configuration information and distribution information for the respective Distribution Messages 1-9, the Distribution Messages 1, 4, and 7 may be routed from feed port 214A in feed A over data path 215A; the Distribution Messages 2, 5, and 8 may be routed from feed port 214B in feed B over data path 215B, and the Distribution Messages 3, 6, and 9 may be routed from feed port 214C in feed C over data path 215C. In addition, the feed generation circuit 212 may, based on filter information, generate a Distribution Message 10 including filtered event data 4 of Event-4 and indicating an event time T4, and distribution information indicating Distribution Message 10 is for client devices 270D, 270E, 270F, and 270G. In addition, based on the configuration information and distribution information for the Distribution Message 10, Distribution Message 10 may be routed from feed port E in feed E over data path 215E.

In block 309, the distribution and fanout circuit 216 may receive the feeds including distribution messages routed over the data paths 215 from the feed generation circuit 212. In addition, in block 309 the distribution and fanout circuit 216 may determine each distinct event indicated in the feeds received at the distribution and fanout circuit 216 over the data paths 215.

In block 310A, for each distinct event determined in block 309, the distribution and fanout circuit 216 may determine each distribution message for the event to be transmitted to a client device of a permissioned user, based on the distribution messages for the event in the feeds received by the distribution and fanout circuit 216 and the configuration information of the system 200. In block 310B, distribution and fanout circuit 216 may determine a distribution time for each distribution message for the event to be transmitted to a client device of a permissioned user as determined in block 310A. In one embodiment, a distribution message to be transmitted for an event, as determined in block 310A, may have a one-to-one correspondence with a distribution message in a feed from the feed generation circuit 212. For example, based on a single distribution message for an event on Feed A on data path 215A, a single distribution message for the event may be determined for transmission from the message delivery circuit 220A to a client device 270A. In another embodiment, distribution messages to be transmitted for an event, as determined in block 310A, may have an N-to-one correspondence with a distribution message in a feed from the feed generation circuit 212. For example, based on a single distribution message for an event on Feed E on data path 215E, four distribution messages, which are replicas of the single distribution message for the event on Feed E, may be determined for transmission from the message delivery circuits 220D, 220E, 220F, and 220G respectively to the client devices 270D, 270E, 270F, and 270G.

In one embodiment, the distribution time for each distribution message for a specific event may be determined as a sum of the event time for the event, a hold delay for the distribution message, and a network latency offset for the distribution message. In one embodiment, the network latency offset may include a propagation delay offset corresponding to the computing device 270 indicated by the distribution information for the distribution message and an optional serialization offset for the distribution message. The propagation delay offset for a computing device 270 indicated for a distribution message may be retrieved from the memory 206, and a serialization offset for a distribution message may be determined, similarly as discussed above. In addition, the hold delay for a given distribution message, which may be a same hold delay used to determine a distribution time for all distribution messages to be published, or alternatively a hold delay having a value specific to a feed including the given distribution message, may be retrieved from the memory 206.

In one embodiment, the network latency offset for a distribution message may include a propagation delay offset and not include a serialization offset.

In another embodiment, the network latency offset for a distribution message may include a propagation delay offset and a serialization offset.

In one embodiment, the distribution message may indicate a byte size of the filtered event data.

In one embodiment, the distribution and fanout circuit 216 may determine, for each distribution message, a byte size of the filtered event data.

In one embodiment, the distribution and fanout circuit 216 may generate a queue in the memory 206 which lists, in chronological order based on respective event times, events, such as determined in block 309, corresponding to the filtered event data in the distribution messages received by the distribution and fanout circuit 216 from the feed generation circuit 212. In addition, the distribution and fanout circuit 216 may, for each event in the queue, list, in chronological order, each distribution message to be transmitted for the event, as determined in block 310A, according to respective distribution times. In one embodiment, where a single distribution message in a feed is replicated multiple times for multiple client devices, such as for a distribution message routed over data path 215E, the distribution and fanout circuit 216 may include in the queue a representation of each replicated distribution message to be transmitted, in chronological order based on distribution times respectively of the replicated distribution messages.

In one embodiment where the network latency offset for a distribution message includes propagation delay offset and not serialization offset, a distribution time for the distribution message may be determined from the Equation DT1: Distribution Time=event time+hold delay+propagation delay offset.

Returning to the example of Event-1, Event-2, Event-3, and Event-4, assume the propagation delay offsets for client devices 270A, 270B, 270C, 270D, 270E, 270F, and 270G are −15 nsec, −10 nsec, −30 nsec, −50 nsec, −60 nsec, −70 nsec, and −80 nsec, T1 is a time zero on the system clock (0 nsec), Delta 1 is 25 nsec such that T2 is 25 nsec, Delta 2 is 30 nsec such that T3 is 30 nsec, and Delta 3 is 200 nsec such that T4 is 200 nsec. The distribution times for the distribution messages of Event-1, Event-2, Event-3, and Event-4 may be determined, based on Equation DT1 and assuming the hold delay is 40 microseconds for all feeds of distribution messages to be published, as follows: For Event-1, Distribution Time 1 for Distribution Message 1 is equal to 0+40 microseconds−15 nsec, or 39.985 microseconds; Distribution Time 2 for Distribution Message 2 is equal to 0+40 microseconds−10 nsec, or 39.990 microseconds; and Distribution Time 3 for Distribution Message 3 is equal to 0+40 microseconds−30 nsec, or 39.970 microseconds. For Event-2, Distribution Time 4 for Distribution Message 4 is equal to 25 nsec+40 microseconds−15 nsec, or 40.010 microseconds; Distribution Time 5 for Distribution Message 5 is equal to 25 nsec+40 microseconds−10 nsec, or 40.015 microseconds; and Distribution Time 6 for Distribution Message 6 is equal to 25 nsec+40 microseconds-30 nsec, or 39.995 microseconds. For Event-3, Distribution Time 7 for Distribution Message 7 is equal to 30 nsec+40 microseconds−15 nsec, or 40.015 microseconds; Distribution Time 8 for Distribution Message 8 is equal to 30 nsec+40 microseconds-10 nsec, or 40.020 microseconds; and Distribution Time 9 for Distribution Message 9 is equal to 30 nsec+40 microseconds−30 nsec, or 40.000 microseconds. For Event-4, Distribution Time 10D for Distribution Message 10D is equal to 200 nsec+40 microseconds−50 nsec, or 40.150 microseconds; Distribution Time 10E for Distribution Message 10E is equal to 200 nsec+40 microseconds−60 nsec, or 40.140 microseconds; Distribution Time 10F for Distribution Message 10F is equal to 200 nsec+40 microseconds−70 nsec, or 40.130 microseconds; and Distribution Time 10G for Distribution Message 10G is equal to 200 nsec+40 microseconds−80 nsec, or 40.120 microseconds, where Distribution Messages 10D, 10E, 10F, and 10G are replicas of a distribution message for the Event-4 on feed E. Table 1 illustrates a representative arrangement of the distribution messages for Event-1, Event-2, Event-3, and Event-4 in the queue, chronologically by event time and also chronologically by distribution times for respective distribution messages of each event, where the distributions times are determined from Equation DT1. For convenient reference, Table 1 further includes other information associated with the respective distribution messages.

TABLE 1

| | | | Desti- | Propagation | Distribution |
|---|---|---|---|---|---|
| | | Filtered | nation | Delay | Time |
| | Distribution | Event | Client | Offset | (micro- |
| Event | Message | Data | Device | (nsec) | seconds) |
| Event-1 | 3 | 1C | 270C | −30 | 39.970 |
| Event-1 | 1 | 1A | 270A | −15 | 39.985 |
| Event-1 | 2 | 1B | 270B | −10 | 39.990 |
| Event-2 | 6 | 2C | 270C | −30 | 39.995 |
| Event-2 | 4 | 2A | 270A | −15 | 40.010 |
| Event-2 | 5 | 2B | 270B | −10 | 40.015 |
| Event-3 | 9 | 3C | 270C | −30 | 40.000 |
| Event-3 | 7 | 3A | 270A | −15 | 40.015 |
| Event-3 | 8 | 3B | 270B | −10 | 40.020 |
| Event-4 | 10G | 4 | 270F | −80 | 40.120 |
| Event-4 | 10F | 4 | 270F | −70 | 40.130 |
| Event-4 | 10E | 4 | 270E | −60 | 40.140 |
| Event-4 | 10D | 4 | 270D | −50 | 40.150 |

In one embodiment where the network latency offset for a distribution message includes propagation delay offset and serialization offset, a distribution time for the distribution message may be determined from the Equation DT2: Distribution Time=event time+hold delay+propagation delay offset+serialization offset.

Returning to the example of Event-1, Event-2, Event-3, and Event-4, assume the serialization offsets are −30 nsec, −40 nsec, and −70 nsec respectively for Distribution Messages 1-3 of Event-1; −30 nsec for each of Distribution Messages 4-6 of Event-2; −50 nsec, −40 nsec and −50 nsec respectively for Distribution Messages 7-9 of Event-3; and −40 nsec for each of Distribution Messages 10D, 10E, 10F, and 10G. The distribution times for the distribution messages of Event-1, Event-2, Event-3, and Event-4, determined from Equation DT2, again assuming the same hold delay of 40 microseconds for all feeds of distribution messages to be published, are as follows: For Event 1, Distribution Time 1 for Distribution Message 1 is equal to 0+40 microseconds−15 nsec−30 nsec, or 39.955 microseconds; Distribution Time 2 for Distribution Message 2 is equal to 0+40 microseconds−10 nsec−40 nsec, or 39.950 microseconds; and Distribution Time 3 for Distribution Message 3 is equal to 0+40 microseconds−30 nsec−70 nsec, or 39.900 microseconds. For Event 2, Distribution Time 4 for Distribution Message 4 is equal to 25 nsec+40 microseconds−15 nsec−30 nsec, or 39.980 microseconds; Distribution Time 5 for Distribution Message 5 is equal to 25 nsec+40 microseconds−10 nsec−30 nsec, or 39.985 microseconds; and Distribution Time 6 for Distribution Message 6 is equal to 25 nsec+40 microseconds−30 nsec−30 nsec, or 39.965 microseconds. For Event 3, Distribution Time 7 for Distribution Message 7 is equal to 30 nsec+40 microseconds−15 nsec−50 nsec, or 39.965 microseconds; Distribution Time 8 for Distribution Message 8 is equal to 30 nsec+40 microseconds−10 nsec−40 nsec, or 39.980 microseconds; and Distribution Time 9 for Distribution Message 9 is equal to 30 nec+40 microseconds−30 nsec−50 nsec, or 39.950 microseconds. For Event-4, Distribution Time 10D for Distribution Message 10D is equal to 200 nsec+40 microseconds−50 nsec−40 nsec, or 40.110 microseconds; Distribution Time 10E for Distribution Message 10E is equal to 200 nsec+40 microseconds−60 nsec−40 nsec, or 40.100 microseconds; Distribution Time 10F for Distribution Message 10F is equal to 200 nsec+40 microseconds−70 nsec−40 nsec, or 40.090 microseconds; and Distribution Time 10G for Distribution Message 10G is equal to 200 nsec+40 microseconds−80 nsec−40 nsec, or 40.080 microseconds, where Distribution Messages 10D, 10E, 10F, and 10G are replicas of a distribution message for the Event-4 on feed E. Table 2 below illustrates a representative arrangement of the distribution messages for the respective events Event-1, Event-2, Event-3, and Event-4 in the queue, chronologically by event time and also chronologically by distribution times for respective distribution messages of each event, where the distributions times are determined from Equation DT2. For convenient reference, Table 2 further includes other information associated with the respective distribution messages.

TABLE 2

| | | | | Propagation | |
|---|---|---|---|---|---|
| | | | Desti- | Delay | Distribution |
| | | Filtered | nation | Offset + | Time |
| | Distribution | Event | Client | Serialization | (micro- |
| Event | Message | Data | Device | Offset (nsec) | seconds) |
| Event-1 | 3 | 1C | 270C | −100 | 39.900 |
| Event-1 | 2 | 1B | 270B | −50 | 39.950 |
| Event-1 | 1 | 1A | 270A | −45 | 39.955 |
| Event-2 | 6 | 2C | 270C | −60 | 39.965 |
| Event-2 | 4 | 2A | 270A | −45 | 39.980 |
| Event-2 | 5 | 2B | 270B | −40 | 39.985 |
| Event-3 | 9 | 3C | 270C | −80 | 39.950 |
| Event-3 | 7 | 3A | 270A | −65 | 39.965 |
| Event-3 | 8 | 3B | 270B | −50 | 39.980 |
| Event-4 | 10G | 4 | 270F | −120 | 40.080 |
| Event-4 | 10F | 4 | 270F | −110 | 40.090 |
| Event-4 | 10E | 4 | 270E | −100 | 40.100 |
| Event-4 | 10D | 4 | 270D | −90 | 40.110 |

The distribution and fanout circuit 216 may determine whether a distribution time for a distribution message in the queue is satisfied, by comparing a current time of the system clock with the distribution time of the distribution message. When the current time of the system clock is determined to be the same or after the distribution time, the distribution time for a distribution message is satisfied.

In block 311, the distribution and fanout circuit 216 may route the distribution messages for each event determined in block 310A, over data paths 218 to respective message delivery circuits 220, according to the configuration information. For example, based on a distribution message for an event on Feed A on data path 215A, the distribution message for the event may be routed over the data path 218A for transmission from the message delivery circuit 220A to a client device 270A. In addition, four distribution messages, which are replicas of a single distribution message routed over data path 215E, may be routed by fanout by the distribution and fanout circuit 216 over respective data paths 218E1, 218E2, 218E3, and 218E4 for transmission by message delivery circuits 220D, 220E, 220F, and 220G, respectively, to client devices 270D, 270E, 270F, and 270G.

In one embodiment, in block 311 a distribution message for an event determined in block 310A may be routed to a message delivery circuit 220 at a routing time that is based on whether the distribution message is one of several distribution messages replicated from a distribution message of a feed on a data path 215 received at the distribution and fanout circuit 216, in accordance with the configuration information. For example, the distribution and fanout circuit 216 may, without delay, route distribution messages on data paths 215A, 215B, 215C, and 215D, upon receipt by the distribution and fanout circuit 216, over data paths 218A, 218B, 218C, and 218D to respective message delivery circuits 220A, 220B, 220C, and 220D. In another example, the distribution and fanout circuit 216 may route the four distribution messages, which are replicated from a distribution message on a feed E of data path 215E, simultaneously by fanout on data paths 218E1, 218E2, 218E3, and 218E4 to respective message delivery circuits 220D, 220E, 220F, and 220G, based on determination that a predetermined routing time for the four distribution messages is satisfied. The predetermined routing time may be equal to a sum of a hold delay for the feed E, a maximum network latency offset of the network latency offsets associated with transmission of the four distribution messages from the message delivery circuits 220A, 220B, 220C, and 220D, and an event time for the four distribution messages. In block 311, when the distribution and fanout circuit 216 determines a current time of the system clock is equal to or after the predetermined routing time for the four distribution messages, the distribution and fanout circuit 216 may determine the predetermined routing time is satisfied and route simultaneously, by fanout, the four distribution messages over data paths 218E1, 218E2, 218E3, and 218E4 respectively to the message delivery circuits 220D, 220E, 220F, and 220G.

In block 312, distribution and fanout circuit 216 may determine whether the system 200 is operating in an event time priority mode or a distribution time priority. In an event time priority mode, all distribution messages for a first event in the queue having an earliest event time are transmitted (published) from the system 200, before any distribution message for a second event in the queue, which is chronologically the next event in the queue following the first event, is transmitted from the system 200. In a distribution time priority mode, a distribution message is transmitted based on a determination that the distribution time of the distribution message is satisfied, regardless of an event time of an event corresponding to the distribution message. In the distribution time priority mode, a distribution message for a second event, which has a second event time after a first event time corresponding to a distribution message for a first event, may be transmitted before the distribution message for the first event.

When the system 200 is operating in an event time priority mode, in block 314 the distribution and fanout circuit 216 may determine a next unpublished event in the queue. A next unpublished event is an event in the queue having an earliest event time and for which none of the distribution messages of the event has been transmitted. Stated another way, a next unpublished event is an event in the queue for which a determination is that a distribution time has not been determined as satisfied for any of the distribution messages for the event in the queue. Referring to Table 1, for example, Event 1 may be determined as a next unpublished event, and after all distribution messages, namely, Distribution Messages 3, 1, and 2, for Event-1 are transmitted in sequence, Event 2 may be determined as the next unpublished event.

In block 316, for a subject event determined as the next unpublished event in block 314, the distribution and fanout circuit 216 may determine whether a distribution time is satisfied for a distribution message of the subject event. In one embodiment, distribution messages for a subject event in the queue are processed chronologically in the order in the queue, to determine whether a distribution time is satisfied. The distribution and fanout circuit 216 may determine a distribution time for a distribution message is satisfied when the current time of the system clock is the same or after the distribution time. When the distribution time for a distribution message is determined not to be satisfied, the distribution and fanout circuit 216 may continue periodically, at predetermined intervals, such as every 2 nsec, to compare the distribution time with the current time of the system clock, and determine whether the distribution time is satisfied. In addition, the distribution and fanout circuit 216 may remove a distribution message from the queue, when a distribution time of the distribution message is determined to be satisfied.

In block 318, for a distribution message for which the distribution time is determined to be satisfied in block 316, the distribution and fanout circuit 216 may cause the distribution message to be transmitted from the message delivery circuit 220 to which the distribution message is routed, over a communication path 260 to the client device 270 communicatively coupled to the message delivery circuit 220. In one embodiment, a distribution message, such as routed over feed A, feed B, feed C, or feed D respectively over data path 218A, 218B, 218C, or 218D, may be at a message delivery circuit 220, such as message delivery circuit 220A, 220B, 220C, or 220D, when the distribution time for the distribution message is determined to be satisfied. In this embodiment, the distribution and fanout circuit 216 may cause the distribution message, which is at a message delivery circuit 220, to be transmitted from the message delivery circuit 220 when the distribution time for the distribution message is determined to be satisfied in block 316.

In one embodiment, the distribution time for a distribution message may be determined to be satisfied at the same instance that, or after, a predetermined routing time for the distribution message is determined to be satisfied in block 311. For example, the distribution time and the predetermined routing time for a distribution message may be determined to be satisfied at a same time, based on respective comparisons of the distribution time and the predetermined routing time with a same current time of the system clock. In the circumstance when both the distribution time and the predetermined routing time for a distribution message are determined to be satisfied at a same time, the distribution message may be routed, as part of a fanout, from the distribution and fanout circuit 216 to a message delivery circuit 220, which transmits the distribution message over a communication path 260 upon receipt without delay. In addition, in the circumstance when the distribution time for a distribution message is determined to be satisfied for an instance of a comparison with a current time of the system clock which is subsequent to a current time of the system clock when an instance of comparison with the current time of the system determines the predetermined routing time for the distribution message is satisfied, the distribution message, which is being held at a message delivery circuit 220, may be transmitted from the message delivery circuit 220, over a communication path 260 to a client device 270 communicatively coupled to the message delivery circuit 220.

In one embodiment, in block 318 the message delivery circuit 220 may transmit a distribution message using a predetermined message format indicated in the configuration information for the system 200. The predetermined message format may have a message format different from a message format of an event message in which event data of the event being published by the distribution message was received by the system 200.

In block 320, the distribution and fanout circuit 216 may determine from the queue whether all distribution messages for the subject event have been transmitted. If the determination in block 320 is that not all distribution messages for the subject event have been transmitted, processing may continue in block 316 to determine whether a distribution time for a distribution message in the queue is satisfied. If the determination in block 320 is all distribution messages for the subject event have been transmitted, processing may continue in block 314 to determine a next unpublished event in the queue, chronologically following the last event for which all the distribution messages have been transmitted.

For example, referring to Table 1, during operation of the system 200 in the event priority mode, assuming Distribution Messages 1 and 3 have been transmitted (based on determinations that Distribution Times 1 and 3 are satisfied) and the system clock currently indicates 39.992 microseconds, in block 316 the distribution and fanout circuit 216, when comparing the current time of the system clock with the earliest distribution times in the queue, may determine that Distribution Time 2 for the Distribution Message 2 of Event-1 is satisfied.

Also, referring to Table 1, during operation of the system 200 in the event priority mode, all distribution messages for Event-2, namely, Distribution Messages 4, 5 and 6, may be transmitted before Distribution Message 9 of Event-3 is transmitted, despite that Distribution Time 9 of Distribution Message 9, which is 40.000 microseconds, is chronologically earlier than the Distribution Times 4 and 5 of 40.010 microseconds and 40.015 microseconds of Distribution Messages 4 and 5 of Event-2, respectively.

Further referring to Table 1, during operation of the system 200 in the event priority mode, Distribution Messages 10D, 10E, 10F, and 10G may be routed to the message delivery circuits 220D, 220E, 220F, 220F at the same time, namely, when the current time of the system clock is 40.120 microseconds, and the Distribution Message 10G may be transmitted from the message delivery circuit 220G upon receipt without delay. The message delivery circuits 220D, 220E, and 220F may be controlled to transmit the Distribution Messages 10D, 10E, and 10F, respectively, in sequence, when the distribution times 40.130, 40.140, and 40.150 microseconds are determined to be satisfied based on comparisons with the current time of the system clock.

In one embodiment, the distribution and fanout circuit 216 may determine whether, for a specific event, several distribution times of respective distribution messages are satisfied, and when this determination occurs, cause transmission of the distribution messages simultaneously from the system 200. The distribution times of several distribution messages for an event may be determined to be satisfied for a same instance of a comparison with a current time of the system clock in block 316, for example, when, due to differences in network latency offsets, a distribution time for a distribution message of a next event in the queue is earlier or the same as a latest distribution time for a prior event in the queue. Referring, for example to Table 1, in the event priority mode, the Distribution Messages 9 and 7 are not transmitted when the current time of the system clock is 40.015 microseconds or earlier, because the system 200 does not transmit any distribution messages of Event-3, until the Distribution Messages 4 and 5 of Event-2, which have distribution times 40.010 microseconds and 40.015 microseconds, are transmitted. When the current time of the system clock is 40.017 nsec, all of the distribution messages for Event-2 may have been transmitted, and the distribution times of both the Distribution Messages 9 and 7 may be determined to be satisfied, such that the Distribution Messages 9 and 7 may be caused to be transmitted simultaneously from the system 200 respectively by the message delivery circuits 220C and 220A.

It is to be understood that, in the distribution time priority mode, the system 200 may control routing of distribution messages, as determined in block 310A, from the distribution and fanout circuit 216 to respective message delivery circuits 220, similarly as discussed above for the event time priority mode.

When in block 312 the system 200 is determined to be operating in a distribution time priority mode, in block 330 the distribution and fanout circuit 216 may determine whether a distribution time for any distribution message in the queue is satisfied. If no distribution time is determined to be satisfied in block 330, processing in block 330 is repeated. In block 330, the distribution and fanout circuit 216 may continuously determine, at predetermined intervals, a current time of the system clock, and compare the current time of the system clock with distribution times of distribution messages in the queue, to determine whether a distribution time for any distribution message is satisfied.

In one embodiment, in block 330 the distribution and fanout circuit 216 may determine an earliest distribution time for a distribution message(s) in the queue, and compare the earliest distribution time with a current time of the system clock to determine whether the earliest distribution time is satisfied.

If a distribution time for a distribution message is determined to be satisfied in block 330, in block 332 the distribution and fanout circuit 216 may cause transmission of the distribution message from the specific message delivery circuit 220 to which the distribution message is routed from the distribution and fanout circuit 216, to the client device 270 communicatively coupled to the specific message delivery circuit 220. In addition, in block 332, the distribution and fanout circuit 216 may remove a distribution message from the queue, when a distribution time of the distribution message is determined to be satisfied in block 330.

In one embodiment, where the distribution times of several distribution messages are determined to be satisfied in block 330, in block 332 the distribution and fanout circuit 216 may cause simultaneous transmission of the several distribution messages from the specific message delivery circuits 220 to which the several distribution messages were routed, respectively to the client devices 270 communicatively coupled to the specific message delivery circuits 220.

In one embodiment, where several distribution messages are determined to be satisfied in block 330 and two or more of the several distribution messages are for a same client device 270, the distribution and fanout circuit 216 may cause transmission of the two or more distribution messages for the same client from a same message delivery circuit 220 in chronological order of event times corresponding to the two or more distribution messages.

Continuing with the example of the Event-1, Event-2, Event-3, and Event-4, referring to Table 2, during operation of the system 200 in the distribution time priority mode, and assuming Distribution Message 3 has been transmitted (based on a determination that the Distribution Time 3 is satisfied) and the system clock currently indicates 39.950 microseconds, the processor 204 may simultaneously cause Distribution Message 2 of Event-1 and Distribution Message 9 of Event-3, which have been routed over data paths 218B and 218C to message delivery circuits 220B and 220C, to transmit Distribution Messages 2 and 9 to the client devices 270B and 270C, respectively. Thus, in the distribution time priority mode, for a same event, the client devices of respective permissioned users may receive the filtered event data at the same or substantially the same time. However, in the distribution time priority mode, some client devices may receive filtered event data of a subsequent event (Event-3) before all client devices permissioned to receive event data of a previous event (Event-1) receive filtered event data of the previous event.

In block 334, the distribution and fanout circuit 216 may determine whether any distribution messages remain in the queue. If the queue does not include any distribution messages, processing continues in block 334 until a distribution message is determined to be in the queue. If the determination in block 334 is the queue includes a distribution message, operation continues from block 330.

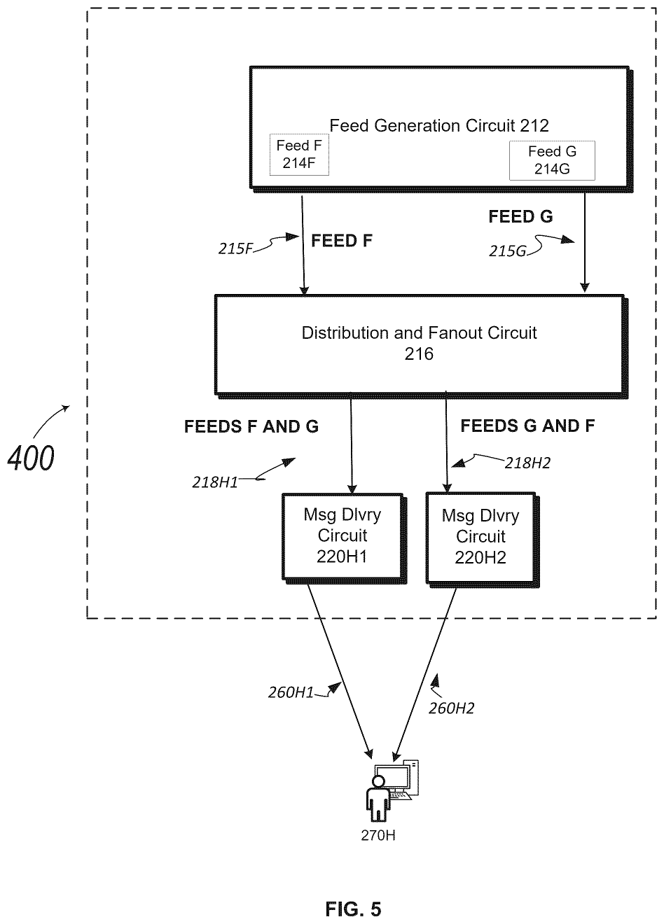

FIG. 5 illustrates an exemplary embodiment of a system 400, which has a same or similar construction and operation as the system 200, and is further configured to implement specific functions and operations in accordance with the present disclosure. For ease of reference and explanation, the system 400 is shown in FIG. 5 only with a feed generation circuit 212, a distribution and fanout circuit 216, and message delivery circuits 220A1 and 220A2. It is to be understood that the system 400 may include all of the components and functionalities of the system 200 as described above.

Referring to FIG. 5, in accordance with configuration information for the system 400, the feed generation circuit 212 may include feed ports 214F and 214G which are coupled respectively over data paths 215F and 215G to the distribution and fanout circuit 216. The distribution and fanout circuit 216 may be coupled over data paths 218H1 and 218H2 respectively to message delivery circuits 220H1 and 220H2. The message delivery circuits 220H1 and 220H1 may be coupled respectively over communication paths 260H1 and 260H2 to a client device 270H. In one embodiment, at least some portion of the communication path 260H1 may be the same as at least some portion of the communication path 260H2. In addition, according to the configuration information for the system 400, a feed F on data path 215F and a feed G on data path 215G may be both for the client device 270H; data path 218H1 may route distribution messages from both feeds F and G to message delivery circuit 220H1; data path 218H2 may route distribution messages from both feeds F and G to message delivery circuit 220H2; and message delivery circuits 220H1 and 220H2 may transmit distribution messages from both feeds F and G to the client device 270H respectively over communication paths 260H1 and 260H2.

In one embodiment, the distribution and fanout circuit 216 may be configured to cause transmission of first and second distribution messages for different events or a same event, which are respectively from feeds F and G and have the same distribution times, one time from each of the message delivery circuits 220H1 and 220H2. In the embodiment, the first and second distribution messages may be caused to be transmitted simultaneously respectively from the message delivery circuits 220H1 and 220H2, and subsequently the second and first distribution messages may be caused to be transmitted simultaneously respectively from the message delivery circuits 220H1 and 220H2. The transmission of the first and second distribution messages, in reverse order at the respective message delivery circuits 220H1 and 220H2, may advantageously provide that the two (first and second) distribution messages, which have the same distribution times, are received at a same or substantially the same time at the client device 270H. In one example, the first distribution message, which is from Feed F on data path 215F, may include filtered event data that is not all of the event data of a specific event, and the second distribution message, which is one of several replicas of a distribution message of Feed G on data path 215G, may include all the event data of the specific event, or some or all event data of another specific event. In addition, several second distribution messages, which are also replicas of the distribution message of Feed G on the data path 215G, may be transmitted to client devices 270 other than client device 270H, based on determinations that distribution times thereof are satisfied at different instances of comparison of the distribution times with a current time of the system clock.

Advantageously, the technical problem of publishing a same event to multiple subscribers permissioned to receive at least some portion of event data describing the same event, to provide that distribution messages including filtered event data of the same event are received at a same or substantially the same time at client devices of respective multiple subscribers, is solved by the technical solution of the present disclosure that transmits distribution messages at respective distribution times that are based on an event time of an event and network latency offsets that equalize differences in network latencies associated with transmission of distribution messages containing filtered event data of a same event to the client devices.

Additionally, the present technology may also be configured as below.
(1) A system including:
at least one programmable integrated circuit communicatively coupled to a plurality of computing devices, in which each computing device includes an event circuit;
in which the at least one programmable integrated circuit is configured to:
   receive, from each event circuit, an event message indicating an event and an event time of the event, in which the event time is based on a time of an electronic clock of the system when the event message indicating the event is transmitted from the event circuit, and in which the event message has a first message format;
   for each event indicated in an event message from an event circuit,
      determine event data and an event time of the event;
      generate, based on filter information, a distribution message including filtered event data of the event for a given client device of a plurality of client devices and the event time;
      determine whether a distribution time of the distribution message is satisfied, by comparing a current time of the electronic clock and a sum of the event time, a hold delay and a network latency offset associated with transmission of the distribution message to the given client device, in which the network latency offset includes a propagation delay offset corresponding to a communication path extending from the at least one programmable integrated circuit to the given client device, in which each client device of the plurality of client devices has a propagation delay offset corresponding to a communication path extending from the at least one programmable integrated circuit to the each client device; and
      when the distribution time of the distribution message is determined to be satisfied, cause a message delivery circuit of the at least one programmable integrated circuit to transmit the distribution message to the given client device, in which the distribution message is transmitted having a second message format different from the first message format.
(2) The system according to (1), in which the network latency offset includes a serialization offset corresponding to a byte size of the filtered event data in the distribution message.
(3) The system according to (1) or (2), in which at least one of the computing devices includes a matching engine or a trading exchange,
in which first given event data of a first given event indicated in a first given event message indicates an order state and party identification information, and
in which first given filtered event data for the first given event, and a first given client device of the plurality of client devices to receive the first given filtered event data, are determined based on the party identification information as given filter information.
(4) The system according to any one of (1) to (3), in which the order state includes a new order, a revised order, cancelation of an existing order or execution an existing order.
(5) The system according to any one of (1) to (4), in which a given event message includes given filter information indicating a first given client device to which to distribute at least some portion of given event data of a given event contained in the given event message.
(6) The system according to any one of (1) to (5), in which the filter information indicates:
at least one first given client device permissioned to receive at least a first portion of given event data of a given event, and
at least one second given client device not permissioned to receive at least a second portion of the given event data of the given event.
(7) The system according to any one of (1) to (6), in which the given event data includes a first financial asset or a party to an order to trade a second financial asset.
(8) The system according to any one of (1) to (7), in which the filter information includes first filter information from at least one of the plurality of client devices or a given event circuit.
(9) The system according to any one of (1) to (8), in which the first message format is Transmission Control Protocol/Internet Protocol and the second message format is Financial Information exchange (FIX®) protocol.
(10) The system according to any one of (1) to (9), in which the at least one programmable integrated circuit includes at least one field programmable gate array (FPGA) and is configured to:
   for a first event indicated in a first event message from a first event circuit of the event circuits, determine first event data and a first event time of the first event from the first event message;
      determine, based on first filter information, first filtered event data of the first event respectively for a plurality of first client devices respectively of users permissioned to receive at least some portion of the first event data;
      generate, for each of the first filtered event data, a first distribution message including first filtered event data for a first given client device of the first client devices and first metadata indicating the first event time of the first event; and
      route the first distribution messages respectively to first message delivery circuits of the FPGA communicatively coupled respectively to the first client devices to which the first distribution messages are indicated for transmission;
   for each first distribution message,
      determine whether a first distribution time of the first distribution message is satisfied, by comparing the current time of the electronic clock and a sum of the first event time, a first hold delay and a first network latency offset associated with transmission of the first distribution message to the first given client device to which the first distribution message is indicated for transmission, and
      when the first distribution time of the first distribution message is determined to be satisfied, cause a given first message delivery circuit of the first message delivery circuits to which the first distribution message is routed to transmit the first distribution message.
(11) The system according to any one of (1) to (10), in which the at least one programmable integrated circuit includes at least one field programmable gate array (FPGA) and is configured to:
for a first event indicated in a first event message from a first event circuit of the event circuits,
   determine first event data and a first event time of the first event from the first event message;
   determine, based on first filter information, same first filtered event data of the first event which is for each of a plurality of first client devices respectively of users permissioned to receive at least some portion of the first event data;
   generate a first distribution message including the same first filtered event data and first metadata indicating the first event time of the first event; and
   replicate, by a fanout circuit of the FPGA, the first distribution message into a plurality of first distribution messages respectively for the plurality of first client devices;
   route, by the fanout circuit, the plurality of first distribution messages respectively to a plurality of first message delivery circuits of the FPGA communicatively coupled respectively to the first client devices; and
   for each given first distribution message of the plurality of first distribution messages,
      determine whether a first distribution time of the given first distribution message is satisfied, by comparing the current time of the electronic clock and a sum of the first event time, a first hold delay and a first network latency offset associated with transmission of the given first distribution message to a first given client device of the first client devices to which the given first distribution message is indicated for transmission, and
      when the first distribution time of the given first distribution message is determined to be satisfied, cause a given first message delivery circuit of the first message delivery circuits to which the given first distribution message is routed to transmit the given first distribution message.
(12) The system according to any one of (1) to (11), in which the plurality of first distribution messages is routed at a same time to the first message delivery circuits based on first network latency offsets associated with transmission of the plurality of first distribution messages respectively to the first client devices.
(13) The system according to any one of (1) to (12), in which the at least one programmable integrated circuit includes a first programmable hardware device configured to receive a given event message from a given event circuit, and a second programmable hardware device configured to transmit a plurality of given distribution messages including respective given filtered event data of given event data of a given event indicated in the given event message respectively to a plurality of given client devices via a plurality of given message delivery circuits when respective given distribution times of the given distribution messages are determined to be satisfied.
(14) The system according to any one of (1) to (13), in which at least one of the first programmable hardware device or the second programmable hardware device is a field programmable gate array (FPGA).
(15) The system according to any one of (1) to (14), in which the second programmable hardware device includes the plurality of given message delivery circuits and a fanout circuit.
(16) The system according to any one of (1) to (15), in which the at least one programmable integrated circuit is configured to:
store, in a memory of the system, a queue representing:
   in chronological order, first events corresponding to first filtered event data contained respectively in first distribution messages, according to first event times respectively of the first events, and
   for each first distribution message for a first event, in chronological order, the first distribution messages according to first distribution times, respectively.
(17) The system according to any one of (1) to (16), in which the at least one programmable integrated circuit is configured to, in an event priority mode,
in chronological order, for each first event in the queue:
   cause given message delivery circuits to transmit the first distribution messages for the first event when first distribution times of the first distribution messages for the first event respectively are determined to be satisfied, based on a comparison of the first distribution times with the current time of the electronic clock of the system.
(18) The system according to any one of (1) to (17), in which the at least one programmable integrated circuit is configured to, in a distribution time priority mode,
cause given message delivery circuits to transmit the first distribution messages for respective first events in chronological order according to when the first distribution times of the first distribution messages for respective first events are determined to be satisfied, based on a comparison of the first distribution times with the current time of the electronic clock of the system.
(19) The system according to any one of (1) to (18), in which the at least one programmable integrated circuit includes at least one field programmable gate array (FPGA) and is configured to:
for a first event indicated in a first event message from a first event circuit of the event circuits,
   determine first event data and a first event time of the first event from the first event message;
   determine, based on first filter information, same first filtered event data of the first event which is for each of a plurality of first client devices respectively of users permissioned to receive at least some portion of the first event data;
   generate a first distribution message including the same first filtered event data and first metadata indicating the first event time of the first event;
   route the first distribution message to a distribution and fanout circuit of the FPGA;
   determine a routing time for routing a plurality of first distribution messages that are replicas of the first distribution message, based on a maximum network latency offset of network latency offsets respectively for the plurality of first client devices to receive the plurality of first distribution messages;
   determine whether the routing time is satisfied, by comparing the current time of the electronic clock and a sum of the first event time, a first hold delay and the maximum network latency offset; and
   when the routing time is determined to be satisfied, route by fanout, by the distribution and fanout circuit, the plurality of first distribution messages to a plurality of first message delivery circuits of the FPGA communicatively coupled respectively to the first client devices.
(20) A method including distributing event information by at least one programmable integrated circuit communicatively coupled to a plurality of computing devices, in which each computing device includes an event circuit, in which the method includes:
   receiving at the at least one programmable integrated circuit, from each event circuit, an event message indicating an event and an event time of the event, in which the event time is based on a time of an electronic clock of the at least one programmable integrated circuit when the event message indicating the event is transmitted from the event circuit, and in which the event message has a first message format;
   for each event indicated in an event message from an event circuit,
      determining, by the at least one programmable integrated circuit, event data and an event time of the event;
      generating, by the at least one programmable integrated circuit, based on filter information, a distribution message including filtered event data of the event for a given client device of a plurality of client devices and the event time;
      determining, by the at least one programmable integrated circuit, whether a distribution time of the distribution message is satisfied, by comparing a current time of the electronic clock and a sum of the event time, a hold delay and a network latency offset associated with transmission of the distribution message to the given client device, in which the network latency offset includes a propagation delay offset corresponding to a communication path extending from the at least one programmable integrated circuit to the given client device, in which each client device of the plurality of client devices has a propagation delay offset corresponding to a communication path extending from the at least one programmable integrated circuit to the each client device; and
      when the distribution time of the distribution message is determined to be satisfied, causing, by the at least one programmable integrated circuit, a message delivery circuit of the at least one programmable integrated circuit to transmit the distribution message to the given client device, in which the distribution message is transmitted having a second message format different from the first message format.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, various steps can be handled in a different order or simultaneously, and steps may be omitted or added.

1. A system comprising:
at least one programmable integrated circuit communicatively coupled to a plurality of computing devices, in which each computing device includes an event circuit;
in which the at least one programmable integrated circuit is configured to:
receive, from each event circuit, an event message indicating an event and an event time of the event, in which the event time is based on a time of an electronic clock of the system when the event message indicating the event is transmitted from the event circuit, and in which the event message has a first message format;
for each event indicated in an event message from an event circuit,
determine event data and an event time of the event;
generate, based on filter information, a distribution message including filtered event data of the event for a given client device of a plurality of client devices and the event time;
determine whether a distribution time of the distribution message is satisfied, by comparing a current time of the electronic clock and a sum of the event time, a hold delay and a network latency offset associated with transmission of the distribution message to the given client device, in which the network latency offset includes a propagation delay offset corresponding to a communication path extending from the at least one programmable integrated circuit to the given client device, in which each client device of the plurality of client devices has a propagation delay offset corresponding to a communication path extending from the at least one programmable integrated circuit to the each client device; and
when the distribution time of the distribution message is determined to be satisfied, cause a message delivery circuit of the at least one programmable integrated circuit to transmit the distribution message to the given client device, in which the distribution message is transmitted having a second message format different from the first message format.

2. The system of claim 1, in which the network latency offset includes a serialization offset corresponding to a byte size of the filtered event data in the distribution message.

3. The system of claim 1, in which at least one of the computing devices includes a matching engine or a trading exchange,
in which first given event data of a first given event indicated in a first given event message indicates an order state and party identification information, and
in which first given filtered event data for the first given event, and a first given client device of the plurality of client devices to receive the first given filtered event data, are determined based on the party identification information as given filter information.

4. The system of claim 3, in which the order state includes a new order, a revised order, cancelation of an existing order or execution an existing order.

5. The system of claim 1, in which a given event message includes given filter information indicating a first given client device to which to distribute at least some portion of given event data of a given event contained in the given event message.

6. The system of claim 1, in which the filter information indicates:
at least one first given client device permissioned to receive at least a first portion of given event data of a given event, and
at least one second given client device not permissioned to receive at least a second portion of the given event data of the given event.

7. The system of claim 6, in which the given event data includes a first financial asset or a party to an order to trade a second financial asset.

8. The system of claim 1, in which the filter information includes first filter information from at least one of the plurality of client devices or a given event circuit.

9. The system of claim 1, in which the first message format is Transmission Control Protocol/Internet Protocol and the second message format is Financial Information exchange (FIX®) protocol.

10. The system of claim 1, in which the at least one programmable integrated circuit includes at least one field programmable gate array (FPGA) and is configured to:
for a first event indicated in a first event message from a first event circuit of the event circuits,
determine first event data and a first event time of the first event from the first event message;
determine, based on first filter information, first filtered event data of the first event respectively for a plurality of first client devices respectively of users permissioned to receive at least some portion of the first event data;
generate, for each of the first filtered event data, a first distribution message including first filtered event data for a first given client device of the first client devices and first metadata indicating the first event time of the first event; and
route the first distribution messages respectively to first message delivery circuits of the FPGA communicatively coupled respectively to the first client devices to which the first distribution messages are indicated for transmission;
for each first distribution message,
determine whether a first distribution time of the first distribution message is satisfied, by comparing the current time of the electronic clock and a sum of the first event time, a first hold delay and a first network latency offset associated with transmission of the first distribution message to the first given client device to which the first distribution message is indicated for transmission, and
when the first distribution time of the first distribution message is determined to be satisfied, cause a given first message delivery circuit of the first message delivery circuits to which the first distribution message is routed to transmit the first distribution message.

11. The system of claim 1, in which the at least one programmable integrated circuit includes at least one field programmable gate array (FPGA) and is configured to:
for a first event indicated in a first event message from a first event circuit of the event circuits,
determine first event data and a first event time of the first event from the first event message;
determine, based on first filter information, same first filtered event data of the first event which is for each of a plurality of first client devices respectively of users permissioned to receive at least some portion of the first event data;
generate a first distribution message including the same first filtered event data and first metadata indicating the first event time of the first event; and
replicate, by a fanout circuit of the FPGA, the first distribution message into a plurality of first distribution messages respectively for the plurality of first client devices;
route, by the fanout circuit, the plurality of first distribution messages respectively to a plurality of first message delivery circuits of the FPGA communicatively coupled respectively to the first client devices; and
for each given first distribution message of the plurality of first distribution messages,
determine whether a first distribution time of the given first distribution message is satisfied, by comparing the current time of the electronic clock and a sum of the first event time, a first hold delay and a first network latency offset associated with transmission of the given first distribution message to a first given client device of the first client devices to which the given first distribution message is indicated for transmission, and
when the first distribution time of the given first distribution message is determined to be satisfied, cause a given first message delivery circuit of the first message delivery circuits to which the given first distribution message is routed to transmit the given first distribution message.

12. The system of claim 11, in which the plurality of first distribution messages is routed at a same time to the first message delivery circuits based on first network latency offsets associated with transmission of the plurality of first distribution messages respectively to the first client devices.

13. The system of claim 1, in which the at least one programmable integrated circuit includes a first programmable hardware device configured to receive a given event message from a given event circuit, and a second programmable hardware device configured to transmit a plurality of given distribution messages including respective given filtered event data of given event data of a given event indicated in the given event message respectively to a plurality of given client devices via a plurality of given message delivery circuits when respective given distribution times of the given distribution messages are determined to be satisfied.

14. The system of claim 13, in which at least one of the first programmable hardware device or the second programmable hardware device is a field programmable gate array (FPGA).

15. The system of claim 14, in which the second programmable hardware device includes the plurality of given message delivery circuits and a fanout circuit.

16. The system of claim 1, in which the at least one programmable integrated circuit is configured to:
store, in a memory of the system, a queue representing:
in chronological order, first events corresponding to first filtered event data contained respectively in first distribution messages, according to first event times respectively of the first events, and
for each first distribution message for a first event, in chronological order, the first distribution messages according to first distribution times, respectively.

17. The system of claim 16, in which the at least one programmable integrated circuit is configured to, in an event priority mode,
in chronological order, for each first event in the queue:
cause given message delivery circuits to transmit the first distribution messages for the first event when first distribution times of the first distribution messages for the first event respectively are determined to be satisfied, based on a comparison of the first distribution times with the current time of the electronic clock of the system.

18. The system of claim 16, in which the at least one programmable integrated circuit is configured to, in a distribution time priority mode,
cause given message delivery circuits to transmit the first distribution messages for respective first events in chronological order according to when the first distribution times of the first distribution messages for respective first events are determined to be satisfied, based on a comparison of the first distribution times with the current time of the electronic clock of the system.

19. The system of claim 1, in which the at least one programmable integrated circuit includes at least one field programmable gate array (FPGA) and is configured to:
for a first event indicated in a first event message from a first event circuit of the event circuits,
determine first event data and a first event time of the first event from the first event message;
determine, based on first filter information, same first filtered event data of the first event which is for each of a plurality of first client devices respectively of users permissioned to receive at least some portion of the first event data;
generate a first distribution message including the same first filtered event data and first metadata indicating the first event time of the first event;
route the first distribution message to a distribution and fanout circuit of the FPGA;
determine a routing time for routing a plurality of first distribution messages that are replicas of the first distribution message, based on a maximum network latency offset of network latency offsets respectively for the plurality of first client devices to receive the plurality of first distribution messages;
determine whether the routing time is satisfied, by comparing the current time of the electronic clock and a sum of the first event time, a first hold delay and the maximum network latency offset; and
when the routing time is determined to be satisfied, route by fanout, by the distribution and fanout circuit, the plurality of first distribution messages to a plurality of first message delivery circuits of the FPGA communicatively coupled respectively to the first client devices.

20. A method for distributing event information by at least one programmable integrated circuit communicatively coupled to a plurality of computing devices, in which each computing device includes an event circuit, in which the method includes:
receiving at the at least one programmable integrated circuit, from each event circuit, an event message indicating an event and an event time of the event, in which the event time is based on a time of an electronic clock of the at least one programmable integrated circuit when the event message indicating the event is transmitted from the event circuit, and in which the event message has a first message format;
for each event indicated in an event message from an event circuit,
determining, by the at least one programmable integrated circuit, event data and an event time of the event;
generating, by the at least one programmable integrated circuit, based on filter information, a distribution message including filtered event data of the event for a given client device of a plurality of client devices and the event time;
determining, by the at least one programmable integrated circuit, whether a distribution time of the distribution message is satisfied, by comparing a current time of the electronic clock and a sum of the event time, a hold delay and a network latency offset associated with transmission of the distribution message to the given client device, in which the network latency offset includes a propagation delay offset corresponding to a communication path extending from the at least one programmable integrated circuit to the given client device, in which each client device of the plurality of client devices has a propagation delay offset corresponding to a communication path extending from the at least one programmable integrated circuit to the each client device; and
when the distribution time of the distribution message is determined to be satisfied, causing, by the at least one programmable integrated circuit, a message delivery circuit of the at least one programmable integrated circuit to transmit the distribution message to the given client device, in which the distribution message is transmitted having a second message format different from the first message format.
